(19) United States
(12) Patent Application Publication
(10) Pub. No.: US 2005/0064336 A1
(43) Pub. Date: Mar. 24, 2005

(54) Unsaturated group-containing multi-branched compounds, curable compositions containing the same, and cured products thereof

(76) Inventor: Hidekazu Miyabe, Hiki-gun (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/951,698

(22) Filed: Sep. 29, 2004

Related U.S. Application Data
(63) Continuation of application No. PCT/JP03/04121, filed on Mar. 31, 2003.

(30) Foreign Application Priority Data
Mar. 29, 2002 (JP) 2002-97023
Dec. 12, 2002 (JP) 2002-360311

(51) Int. Cl. G03C 1/73

(52) U.S. Cl. 430/281.1

(57) ABSTRACT

A curable composition is obtained by mixing a polymerization initiator (B) or further a thermosetting component with an unsaturated group-containing multi-branched compound (A-1)-(A-4) obtained by the reaction of (a) a compound containing at least two epoxy groups in its molecule with (b) a compound containing at least two (but at least three when the component (a) mentioned above is a polyfunctional epoxy compound containing two epoxy groups) carboxyl groups and/or phenolic hydroxyl groups in its molecule and (c) an unsaturated monocarboxylic acid or a compound containing at least one unsaturated double bond-containing group, or an unsaturated group-containing multi-branched compound (A-5)-(A-8) having a carboxyl group and obtained by further causing (d) a polybasic acid anhydride to react with a hydroxyl group of the unsaturated group-containing multi-branched compound mentioned above.

### CROSS-REFERENCE TO RELATED APPLICATIONS

This is a continuation of Application PCT/JP03/04121, filed Mar. 31, 2003, which was published under PCT Article 21(2).

### BACKGROUND OF THE INVENTION

1. Field of the Invention

This invention relates to an unsaturated group-containing multi-branched compound which may be advantageously used as a photocurable component and/or a thermosetting component in various application fields. This invention further relates to a curable composition containing the above-mentioned unsaturated group-containing multi-branched compound, which composition cures promptly by irradiation of an actinic energy ray such as an ultraviolet ray or an electron beam or further cures by heating, thereby giving rise to a cured product excelling in adhesiveness to a substrate, mechanical properties, resistance to heat, flexibility, resistance to chemicals, electrical insulation properties, etc. and to a cured product obtained therefrom. This composition may be used in wide range of application fields as an adhesive, a coating material, and a solder resist, an etching resist, an interlaminar insulating material for a build-up board, a plating resist and a dry film to be used in the manufacture of printed circuit boards.

2. Description of the Prior Art

The curing of a resin by irradiation of an actinic energy ray is widely utilized in painting of metal, coating of wood, printing ink, electronic materials, etc. owing to its high curing speed and solvent-free. A photocurable composition used in these technical fields generally comprises an unsaturated double bond-containing prepolymer, a polymerizable monomer, and a photopolymerization initiator as essential components. As the above-mentioned prepolymer preponderantly used as a photocurable component, a polyester acrylate, a urethane acrylate, and an epoxy acrylate may be cited. Since these prepolymers contain polymerizable unsaturated groups therein, they can be cross-linked by mixing with a compound which generates radicals by irradiation of an actinic energy ray (photopolymerization initiator).

However, since these radically polymerizable prepolymers generally have a small molecular weight and instantly cure by irradiation of an actinic energy ray, thereby causing residual stress in its coating film, they pose the problems of decreasing the adhesiveness to a substrate and mechanical properties. For the purpose of solving such problems, the modification of the radically polymerizable prepolymer to the higher polymeric structure has been proposed. However, a large amount of a reactive diluent is required to adjust the viscosity of a composition containing such a prepolymer to that allowing application. Accordingly, such an actinic energy ray-curable composition is poor in toughness, mechanical properties, resistance to chemicals, etc. and thus its use is limited at present.

In order to solve such problems, a multi-branched compound containing an amino group in its molecule is proposed in Japanese published patent application, JP 11-193321,A, for example. Although this multi-branched compound has a high molecular weight, the viscosity of its solution is low. Therefore, it has the advantage that the amount of a low molecular weight ingredient to be added thereto at the time of preparing a curable composition may be lowered. However, its use is limited because this compound contains in its molecule an amino group which adversely affects the electrical properties and does not contain in its side chain a substituent group which can be chemically modified.

In view of the above circumstances, at present an actinic energy ray-curable resin composition containing an epoxy acrylate-based photosensitive resin as a base polymer is preponderantly used as a resist material for a printed circuit board or the like. With such an actinic energy ray-curable resin composition containing an epoxy acrylate-based photosensitive resin as a base polymer, it is possible to obtain a cured product having high hardness and excelling in such properties as heat resistance and electrical insulating properties by increasing the cross-linking density, but by contraries having such drawbacks as low flexibility and low toughness. On the other hand, in order to improve flexibility and toughness, consideration will be generally directed to such countermeasures that the use of a crystalline monomer is avoided and the base polymer is prepared in the linear form. However, these countermeasures will pose another problem by contraries that such properties as mechanical properties and heat resistance will be deteriorated.

The physical properties of a coating film depends on the primary molecular weight of a main resin contained in a composition. If the molecular weight is increased, the entanglement of the molecule chains of linear high polymers increases, which will result in such problems that the solubility of the polymer decreases and the developing properties of the composition is deteriorated.

On the other hand, in order to improve the heat resistance of a coating film, it will be thought of by a person skilled in the art that a highly crystalline monomer ingredient should be introduced into the polymer as mentioned above. However, this countermeasure will pose such a problem that the film forming properties will be deteriorated. Further, if the cross-linking density becomes large, by contraries the resultant cured product tends to become brittle and the shrinkage on curing and dimensional change become large.

As described above, a curable composition capable of giving rise to a cured product which exhibits the well-balanced mechanical properties such as strength, elongation, and toughness and other properties such as heat resistance, flexibility, and resistance to chemicals at a high level has not yet been found up to now.

### SUMMARY OF THE INVENTION

The present invention has been made in view of the problems of the prior art mentioned above and has an object to provide an unsaturated group-containing multi-branched compound, or further an alkali-soluble, unsaturated group-containing multi-branched compound, which cures promptly by irradiation of an actinic energy ray such as an ultraviolet ray or an electron beam or further by heating, thereby capable of producing a cured product excelling in adhesiveness to a substrate, heat resistance, flexibility, and mechanical properties, and which may be advantageously used as a photocurable component and/or a thermosetting component in various application fields.

A further object of the present invention is to provide a curable composition which cures promptly by irradiation of an actinic energy ray such as an ultraviolet ray or an electron beam or further by heating, which excels in adhesiveness to a substrate, and which is capable of producing a cured product excelling in various properties such as mechanical properties, heat resistance, heat stability, flexibility, resistance to chemicals, and electrical insulating properties, and a cured product obtained therefrom.

To accomplish the objects mentioned above, in accordance with a first aspect of the present invention, there is provided an unsaturated group-containing multi-branched compound. The first mode thereof is an unsaturated group-containing multi-branched compound characterized by having a multi-branched structure having at least two photosensitive, unsaturated double bonds at its terminal parts, and the second mode is an unsaturated group-containing multi-branched compound characterized by having a multi-branched structure having at least two photosensitive, unsaturated double bonds at its terminal parts and at least one carboxyl group.

The unsaturated group-containing multi-branched compound of the first mode mentioned above includes four embodiments. The first embodiment thereof is an unsaturated group-containing multi-branched compound (A-1) obtained by the reaction of (a) a compound containing at least two epoxy groups in its molecule with (b) a compound containing at least two (but at least three when the component (a) mentioned above is a compound containing two epoxy groups) carboxyl groups in its molecule and (c) an unsaturated monocarboxylic acid.

The second embodiment is an unsaturated group-containing multi-branched compound (A-2) obtained by the reaction of (a) a compound containing at least two epoxy groups in its molecule with (b) a compound containing at least two (but at least three when the component (a) mentioned above is a compound containing two epoxy groups) carboxyl groups in its molecule and (c′) a compound containing at least one unsaturated double bond-containing group.

The third embodiment is an unsaturated group-containing multi-branched compound (A-3) obtained by the reaction of (a) a compound containing at least two epoxy groups in its molecule with (b′) a phenolic compound containing at least two (but at least three when the component (a) mentioned above is a compound containing two epoxy groups) hydroxyl groups in its molecule and (c′) a compound containing at least one unsaturated double bond-containing group.

The fourth embodiment is an unsaturated group-containing multi-branched compound (A-4) obtained by the reaction of (a) a compound containing at least two epoxy groups in its molecule with (b″) a compound containing at least one (but at least three functional groups in total when the component (a) mentioned above is a compound containing two epoxy groups) of carboxyl group and phenolic hydroxyl group severally in its molecule and (c′) a compound containing at least one unsaturated double bond-containing group.

In accordance with the present invention, there are in particular provided the unsaturated group-containing multi-branched compound (A-2), (A-3), and (A-4) mentioned above.

Since these unsaturated group-containing multi-branched compounds (A-1)-(A-4) have the particular structures containing in combination hydroxyl groups caused by the ring opening addition reaction of the epoxy groups and polymerizable unsaturated bonds at their terminals and the content of the polymerizable group therein per one molecule is high, they are capable of curing promptly by short-time irradiation of an actinic energy ray and further capable of curing by heating. Further, the resultant cured products exhibit excellent adhesiveness to various substrates owing to the hydrogen bonding nature of the hydroxyl group. Moreover, they exhibit slight shrinkage on curing and give the cured products excelling in mechanical properties such as strength, elongation, and toughness owing to the multi-branched structure having ether linkages and/or ester linkages. Furthermore, the compounds exhibit high solubility in various solvents and have the characteristic of lowering the viscosity of their solutions owing to the multi-branched structure.

Further, the unsaturated group-containing multi-branched compound of the second mode mentioned above also includes four embodiments. The first embodiment thereof is an unsaturated group-containing multi-branched compound (A-5) obtained by further causing (d) a polybasic acid anhydride to react with a hydroxyl group of the unsaturated group-containing multi-branched compound obtained by the reaction of (a) a compound containing at least two epoxy groups in its molecule with (b) a compound containing at least two (but at least three when the component (a) mentioned above is a compound containing two epoxy groups) carboxyl groups in its molecule and (c) an unsaturated monocarboxylic acid.

The second embodiment is an unsaturated group-containing multi-branched compound (A-6) obtained by further causing (d) a polybasic acid anhydride to react with a hydroxyl group of the unsaturated group-containing multi-branched compound obtained by the reaction of (a) a compound containing at least two epoxy groups in its molecule with (b) a compound containing at least two (but at least three when the component (a) mentioned above is a compound containing two epoxy groups) carboxyl groups in its molecule and (c′) a compound containing at least one unsaturated double bond-containing group.

The third embodiment is an unsaturated group-containing multi-branched compound (A-7) obtained by further causing (d) a polybasic acid anhydride to react with a hydroxyl group of the unsaturated group-containing multi-branched compound obtained by the reaction of (a) a compound containing at least two epoxy groups in its molecule with (b′) a phenolic compound containing at least two (but at least three when the component (a) mentioned above is a compound containing two epoxy groups) hydroxyl groups in its molecule and (c′) a compound containing at least one unsaturated double bond-containing group.

Further, the fourth embodiment is an unsaturated group-containing multi-branched compound (A-8) obtained by further causing (d) a polybasic acid anhydride to react with a hydroxyl group of the unsaturated group-containing multi-branched compound obtained by the reaction of (a) a compound containing at least two epoxy groups in its molecule with (b″) a compound containing at least one (but at least three functional groups in total when the component (a) mentioned above is a compound containing two epoxy groups) of carboxyl group and phenolic hydroxyl group severally in its molecule and (c′) a compound containing at least one unsaturated double bond-containing group.

In accordance with the present invention, there are in particular provided the unsaturated group-containing multi-branched compound (A-6), (A-7), and (A-8) mentioned above.

Since these unsaturated group-containing multi-branched compounds (A-5)-(A-8) have a large number of polymerizable groups at their terminals, they are the resins exhibiting excellent photocuring properties. Further, since they have carboxyl groups introduced therein by the reaction of the polybasic acid anhydride to the pendant hydroxyl group of each of the unsaturated group-containing multi-branched compounds (A-1) to (A-4), they exhibit excellent solubility in an aqueous alkaline solution and thus are useful as an alkali-developing type photosensitive resin.

In accordance with a second aspect of the present invention, there is provided a curable composition containing the unsaturated group-containing multi-branched compound mentioned above. The fundamental first embodiment thereof is characterized by comprising (A) the unsaturated group-containing multi-branched compound mentioned above (either one of (A-1) to (A-8) or a mixture of two or more members) and (B) a polymerization initiator as essential components.

The second embodiment of the curable composition of the present invention is characterized by further comprising (C) a thermosetting component in addition to the components (A) and (B) mentioned above.

The curable composition of the present invention may be used in the form of liquid as it is or in the form of a dry film.

Further, in accordance with a third aspect of the present invention, there is provided a cured product obtained by curing the curable resin composition mentioned above by irradiation with an actinic energy ray and/or by heating. Although the cured product may be applicable to various fields, it may be advantageously applicable to the formation of a solder resist layer and an interlaminar insulating layer in a printed circuit board.

### BRIEF DESCRIPTION OF THE DRAWINGS

FIG. 1 is a graph showing the IR spectrum of the unsaturated group-containing multi-branched compound produced in Example 1.

FIG. 2 is a graph showing the IR spectrum of the unsaturated group-containing multi-branched compound produced in Example 2.

FIG. 3 is a graph showing the IR spectrum of the unsaturated group-containing multi-branched compound containing carboxyl groups and produced in Example 3.

FIG. 4 is a graph showing the IR spectrum of the unsaturated group-containing multi-branched compound containing carboxyl groups and produced in Example 4.

FIG. 5 is a graph showing the IR spectrum of the unsaturated group-containing multi-branched compound produced in Example 5.

FIG. 6 is a graph showing the IR spectrum of the unsaturated group-containing multi-branched compound containing carboxyl groups and produced in Example 6.

FIG. 7 is a graph showing the IR spectrum of the unsaturated group-containing multi-branched compound containing carboxyl groups and produced in Example 7.

### DETAILED DESCRIPTION OF THE PREFERRED EMBODIMENTS

The present inventor, after pursuing a diligent study to solve the problems mentioned above, has found that since the unsaturated group-containing multi-branched compounds (A-1) and (A-2) obtained by the polyaddition reaction of
(a) a compound containing at least two epoxy groups in its molecule (hereinafter referred to briefly as a polyfunctional epoxy compound) with
(b) a compound containing at least two (but at least three when the component (a) mentioned above is a polyfunctional epoxy compound containing two epoxy groups) carboxyl groups in its molecule (hereinafter referred to briefly as a polycarboxylic acid), and
(c) an unsaturated monocarboxylic acid or (c′) a compound containing at least one unsaturated double bond-containing group,
   and the unsaturated group-containing multi-branched compounds (A-3) and (A-4) obtained by the reaction of
(a) a polyfunctional epoxy compound mentioned above with
(b′) a phenolic compound containing at least two (but at least three when the component (a) mentioned above is a compound containing two epoxy groups) hydroxyl groups in its molecule (hereinafter referred to briefly as a polyphenolic compound) or (b″) a compound containing at least one (but at least three functional groups in total when the component (a) mentioned above is a compound containing two epoxy groups) of carboxyl group and phenolic hydroxyl group severally in its molecule (hereinafter referred to briefly as a hydroxyl group-containing carboxylic acid), and
(c′) a compound containing at least one unsaturated double bond-containing group,
   have the particular structures containing in combination secondary hydroxyl groups caused by the ring opening reaction of the epoxy groups and unsaturated bonds at their terminals and the content of the polymerizable group therein per one molecule is high, they are capable of curing promptly by short-time irradiation of an actinic energy ray, also capable of thermally curing by heat radicals owing to the presence of the unsaturated double bonds, and further capable of thermally curing by addition of a curing agent (for example, isocyanates) which can react with a hydroxyl group owing to the presence of the pendant secondary hydroxyl groups mentioned above. The present inventor has further found that the resultant cured products exhibit excellent adhesiveness to various substrates owing to the hydrogen bonding nature of the secondary hydroxyl group and that since the compounds have the multi-branched structure having ether linkages and/or ester linkages, the composition containing such a compound as a curable component exhibits little shrinkage on curing and gives a cured product excelling in mechanical properties, such as strength and toughness, and heat resistance in combination. Further, owing to the multi-branched structure, the molecules scarcely entangle with each other in comparison with a linear polymer having the same molecular weight. Therefore, the compounds exhibit high solubility in various solvents and have the characteristic of lowering the viscosity of their solutions. As a result, it is possible to decrease the amount of a solvent. Moreover, a monomer can be freely selected when the compound is synthesized. The solubility of the compound is further improved by incorporating a highly crystalline monomer in its skeleton, which results in good film forming properties.

Further, in accordance with the present inventor's study, the unsaturated group-containing multi-branched compounds (A-5)-(A-8) having carboxyl groups and obtained by the reaction of (d) a polybasic acid anhydride to the secondary hydroxyl group of each of the unsaturated group-containing multi-branched compounds (A-1) to (A-4) mentioned above are the resins exhibiting excellent photocuring properties because they have a large number of polymerizable groups at their terminals and also the alkali-developing type photosensitive resins because they exhibit excellent solubility in an aqueous alkaline solution owing to the presence of the carboxyl groups introduced in the side chains thereof.

Accordingly, the unsaturated group-containing multi-branched compounds ((A-1) to (A-8)) may be advantageously used as a photocurable component and/or a thermosetting component in various application fields because they have excellent properties as mentioned above.

Now, the present invention will be described in detail below.

First, the unsaturated group-containing multi-branched compound (A-1) of the present invention may be produced by the polyaddition reaction of a polyfunctional epoxy compound (a) with a polycarboxylic acid (b) and an unsaturated monocarboxylic acid (c) in the presence of a reaction accelerator.

For instance, in case either one of the polyfunctional epoxy compound (a) and the polycarboxylic acid (b) is a bifunctional compound and the other is a trifunctional compound, for example, when a tricarboxylic acid is used as the polycarboxylic acid and represented by “X”, a bifunctional epoxy compound is used as the polyfunctional epoxy compound and represented by “Y”, and the unsaturated monocarboxylic acid is represented by “Z”, the resultant polymer has the multi-branched structure as represented by the following general formula (1), for example.

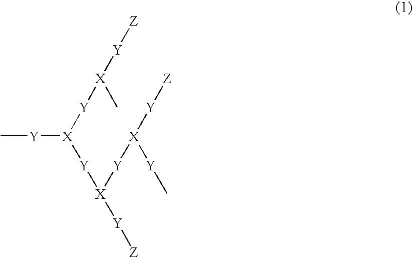

The similar multi-branched structure is obtained even when the bifunctional compound and the trifunctional compound are reversed, i.e. in the case of the polyaddition rection of a trifunctional epoxy compound containing three epoxy groups in its molecule and a dicarboxylic acid containing two carboxyl groups in its molecule. The unsaturated monocarboxylic acid functions as a reaction terminator and reacts with the epoxy group. Accordingly, the multi-branched compound has at its terminal parts unsaturated groups introduced by the addition of the unsaturated monocarboxylic acid to the epoxy group. Similarly, the multi-branched structure is obtained when both the polyfunctional epoxy compound (a) and the polycarboxylic acid (b) are the trifunctional or more polyfunctional compounds, though the resultant structure becomes more complicatedly branched state.

The unsaturated group-containing multi-branched compound (A-3) of the present invention may be produced by the polyaddition reaction and/or polycondensation reaction of a polyfunctional epoxy compound (a) with a polyphenolic compound (b′) and a compound (c′) containing at least one unsaturated double bond-containing group which is capable of reacting with a phenolic hydroxyl group and/or an epoxy group, in the presence of a reaction accelerator.

For instance, in case either one of the polyfunctional epoxy compound (a) and the polyphenolic compound (b′) is a bifunctional compound and the other is a trifunctional compound, for example, when a trifunctional phenolic compound is used as the polyphenolic compound and represented by “x”, a bifunctional epoxy compound is used as the polyfunctional epoxy compound and represented by “Y”, and the compound having an unsaturated double bond is represented by “Z”, the resultant polymer has the multi-branched structure as represented by the following general formula (2), for example.

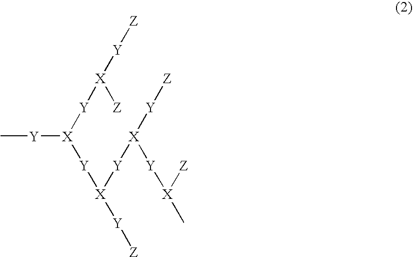

The similar multi-branched structure is obtained even when the bifunctional compound and the trifunctional compound are reversed, i.e. in the case of the polyaddition rection of a trifunctional epoxy compound containing three epoxy groups in its molecule and a bifunctional phenolic compound containing two hydroxyl groups in its molecule. The compound having an unsaturated double bond functions as a reaction terminator. In case this compound reacts with the phenolic hydroxyl group, the multi-branched compound has at its terminal parts unsaturated groups introduced by the addition or condensation of the unsaturated double bond-containing group to the phenolic hydroxyl group. Similarly, the multi-branched structure is obtained when both the polyfunctional epoxy compound (a) and the polyphenolic compound (b′) are the trifunctional or more polyfunctional compounds, though the resultant structure becomes more complicatedly branched state.

The unsaturated group-containing multi-branched compounds (A-2) and (A-4) of the present invention also have the multi-branched structures similar to those mentioned above.

The structure mentioned above will be explained more concretely by the use of chemical formulas. For example, when a bifunctional epoxy compound to be described hereinafter is used as the polyfunctional epoxy compound (a) and a tricarboxylic acid to be described hereinafter is used as the polycarboxylic acid (b), the unsaturated group-containing multi-branched compound (A-1) having the skeletal structure unit as represented by the following general formula (3), for example, may be obtained. Further, when a trifunctional epoxy compound is used as the polyfunctional epoxy compound (a) and a dicarboxylic acid is used as the polycarboxylic acid (b), the unsaturated group-containing multi-branched compound (A-1) having the skeletal structure unit as represented by the following general formula (4), for example, may be obtained.

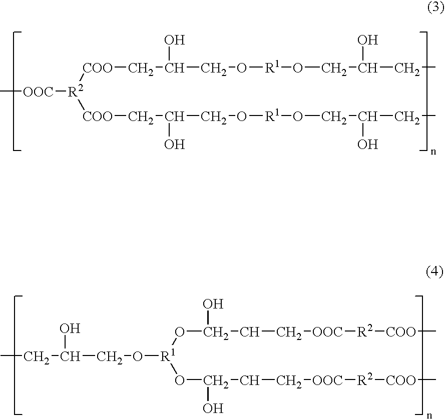

In the formulas, R¹ represents a polyfunctional epoxy residue, R² represents a polycarboxylic acid residue, and “n” is an integer of 1 or more, the upper limit of which may be suitably controlled depending on a desired molecular weight.

In the above-mentioned general formulas (3) and (4), the terminal groups are those as represented by the following general formulas (5) to (9).

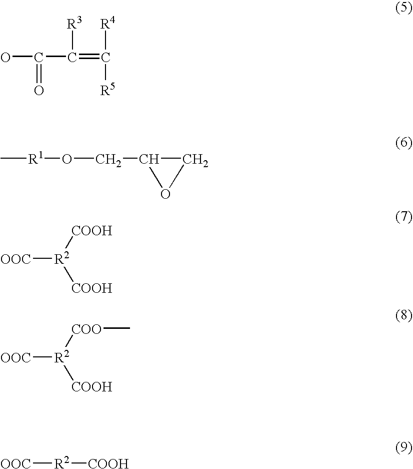

In the formulas, R¹ and R² represent the same meanings as mentioned above, and R³, R⁴, and R⁵ independently represent a hydrogen atom, an alkyl group of 1 to 6 carbon atoms, an aryl group, an aralkyl group, a cyano group, a fluorine atom, or a furyl group.

Specifically, the terminal of a part to which an unsaturated group was introduced by the addition of the unsaturated monocarboxylic acid to the epoxy group of the terminal part becomes the terminal group represented by the general formula (5). The terminal of a part in which the unsaturated monocarboxylic acid was not added to the epoxy group of the terminal part becomes the terminal group represented by the general formula (6). Further, when the carboxyl group which did not react with the polyfunctional epoxy compound (a) remains in the polycarboxylic acid (b), the terminal in that part becomes the terminal group represented by the general formula (7), (8), or (9), though a proportion thereof is low. It should be noted that the general formulas (7) and (8) correspond to the case that a tricarboxylic acid is used and the general formula (9) corresponds to the case that a dicarboxylic acid is used. Incidentally, although a glycidyl ether compound is exemplified in the general formulas (3), (4), and (6), a glycidyl ester compound and a glycidyl amine compound may be used.

The reaction mentioned above may be performed by either method of mixing the polyfunctional epoxy compound (a), the polycarboxylic acid (b) and the unsaturated monocarboxylic acid (c) together and carrying out the reaction thereof (one pot method) or adding the unsaturated monocarboxylic acid (c) to the reaction mixture of the polyfunctional epoxy compound (a) and the polycarboxylic acid (b) after completion of the polyaddition reaction thereof and effecting the reaction thereof (successive method). From the viewpoint of workability, however, the one pot method which carries out the reaction by mixing three components, the polyfunctional epoxy compound (a), the polycarboxylic acid (b), and the unsaturated monocarboxylic acid (c) together proves to be preferable.

In the above-mentioned reaction, the ratio of the polycarboxylic acid (b) to the polyfunctional epoxy compound (a) (the charging ratio in the reaction mixture) in a molar ratio of respective functional groups is desired to be in the range of 0.1≦[number of mols of the carboxyl group of the polycarboxylic acid]/[number of mols of the epoxy group of the polyfunctional epoxy compound]≦1, more preferably in the range of 0.2≦[number of mols of the carboxyl group of the polycarboxylic acid]/[number of mols of the epoxy group of the polyfunctional epoxy compound]≦0.8. If the equivalent ratio mentioned above is less than 0.1, the produced multi-branched compound will have insufficient polycarboxylic acid skeletons introduced therein and thus the resin having a desired molecular weight will not be obtained and, as a result, the resin undesirably fails to allow a coating film to have sufficient properties. Conversely, if the equivalent ratio mentioned above exceeds 1, the polymerization terminal in the polyaddition reaction tends to become carboxyl group. As a result, the subsequent addition reaction of the unsaturated monocarboxylic acid (c) will not easily take place and the introduction of polymerizable groups is attained only with difficulty. In other words, irrespective of the number of valence of the polyfunctional epoxy compound (a) and that of the polycarboxylic acid (b), by carrying out the reaction under such conditions that the functional group of the polyfunctional epoxy compound (a) is more superfluous than the functional group (carboxyl group) of the polycarboxylic acid (b), it is possible to locate the epoxy groups in the terminal parts and to add the unsaturated monocarboxylic acid (c) to these groups to introduce a large number of unsaturated groups. By varying the reaction conditions such as the reaction time and the reaction temperature and by controlling the amount of the polycarboxylic acid (b) to be used in the range of the equivalent ratio mentioned above, it is possible to control the molecular weight and the branched state of the produced multi-branched compound to a certain extent.

Further, the ratio of the unsaturated monocarboxylic acid (c) to the polyfunctional epoxy compound (a) (the charging ratio in the reaction mixture) in a molar ratio of respective functional groups is desired to be in the range of 0.1≦[number of mols of the carboxyl group of the unsaturated monocarboxylic acid]/[number of mols of the epoxy group of the polyfunctional epoxy compound]≦10, more preferably in the range of 0.2≦[number of mols of the carboxyl group of the unsaturated monocarboxylic acid]/[number of mols of the epoxy group of the polyfunctional epoxy compound]≦5. By controlling the amount of the unsaturated monocarboxylic acid (c) to be used and the reaction method (one pot method or successive method), it is possible to control the proportion of the unsaturated group to be introduced and the molecular weight.

In this way, it is possible to synthesize the unsaturated group-containing multi-branched compound (A-1) assuming a liquid state or a solid state depending on the size of the molecular weight.

Further, when a bifunctional epoxy compound to be described hereinafter is used as the polyfunctional epoxy compound (a) and a trifunctional phenolic compound to be described hereinafter is used as the polyphenolic compound (b′), for example, the unsaturated group-containing multi-branched compound (A-3) having the skeletal structure unit as represented by the following general formula (10), for example, may be obtained. When a trifunctional epoxy compound is used as the polyfunctional epoxy compound (a) and a bivalent phenolic compound is used as the polyphenolic compound (b′), for example, the unsaturated group-containing multi-branched compound (A-3) having the skeletal structure unit as represented by the following general formula (11), for example, may be obtained.

As the compound (c′) containing at least one unsaturated double bond-containing group, the unsaturated monocarboxylic acid (c) mentioned above and a compound (c′-1) which can react with a hydroxyl group, such as (meth)acryloyl halide or cyclic ethers containing an unsaturated double bond-containing group, may be cited. These compounds are used as follows, for example:

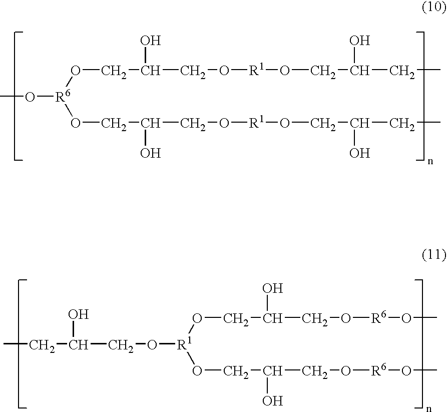

In the formulas, R¹ represents a polyfunctional epoxy residue, R⁶ represents a polyphenolic compound residue, and “n” is an integer of 1 or more, the upper limit of which may be suitably controlled depending on a desired molecular weight.

In the general formulas (10) and (11) mentioned above, the terminal groups are such groups as represented by the following general formulas (12) to (16).

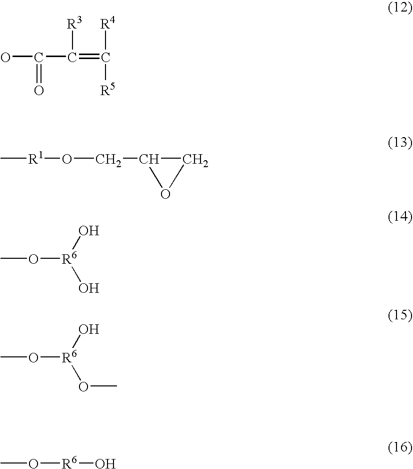

In the formulas, R¹ represents a polyfunctional epoxy residue, R⁶ represents a polyphenolic compound residue, and R³, R⁴, and R⁵ independently represent a hydrogen atom, an alkyl group of 1 to 6 carbon atoms, an aryl group, an aralkyl group, a cyano group, a fluorine atom, or a furyl group.

Specifically, the terminal of a part to which an unsaturated group was introduced by the addition of the unsaturated monocarboxylic acid (c) to the epoxy group of the terminal part and/or the terminal of a part to which an unsaturated group was introduced by the condensation or addition of the compound (c′-1) which can react with a hydroxyl group, such as (meth)acryloyl halide or cyclic ethers containing an unsaturated double bond-containing group, for example, to the phenolic hydroxyl group become the terminal group represented by the general formula (12). The terminal of a part in which the unsaturated monocarboxylic acid was not added to the epoxy group of the terminal part becomes the terminal group represented by the general formula (13). The terminal of a part in which the compound (c′-1) which can react with a hydroxyl group, such as (meth)acryloyl halide or cyclic ethers containing an unsaturated double bond-containing group, for example, was not condensed with or added to the phenolic hydroxyl group becomes the terminal group represented by the general formula (14), (15), or (16). It should be noted that the general formulas (14) and (15) correspond to the case that a trifunctional phenolic compound is used and the general formula (16) corresponds to the case that a bifunctional phenolic is used. Incidentally, although a glycidyl ether compound is exemplified in the general formulas (10), (11), and (13), a glycidyl ester compound and a glycidyl amine compound may be used.

The reaction mentioned above may be performed by either method of mixing the polyfunctional epoxy compound (a), the polyphenolic compound (b′), and the unsaturated monocarboxylic acid (c) or the compound (c′-1) which can react with a hydroxyl group, such as (meth)acryloyl halide or cyclic ethers containing an unsaturated double bond-containing group, together and carrying out the reaction thereof (one pot method) or adding the unsaturated monocarboxylic acid (c) and/or the compound (c′-1) which can react with a hydroxyl group, such as (meth)acryloyl halide or cyclic ethers containing an unsaturated double bond-containing group, into the reaction mixture of the polyfunctional epoxy compound (a) and the polyphenolic compound. (b′) after completion of the polyaddition reaction thereof and effecting the reaction thereof (successive method). From the viewpoint of the degree of branching, the molecular weight, and the reproducibility of synthesis, however, when the difference in reactivity between the epoxy group and a phenol or a carboxylic acid is taken into consideration, successive method which carries out the reaction by adding the unsaturated monocarboxylic acid (c) and/or the compound (c′-1) which can react with a hydroxyl group, such as (meth)acryloyl halide or cyclic ethers containing an unsaturated double bond-containing group, into the reaction mixture of the polyfunctional epoxy compound (a) and the polyphenolic compound (b′) after completion of the polyaddition reaction thereof proves to be preferable.

In the above-mentioned reaction, the ratio of the polyphenolic compound (b′) to the polyfunctional epoxy compound (a) (the charging ratio in the reaction mixture) in a molar ratio of respective functional groups is desired to be in the range of 0.1≦[number of mols of the phenol group of the polyphenolic compound]/[number of mols of the epoxy group of the polyfunctional epoxy compound]≦1, more preferably in the range of 0.2≦[number of mols of the phenol group of the polyphenolic compound]/[number of mols of the epoxy group of the polyfunctional epoxy compound] ≦0.8. If the equivalent ratio mentioned above is less than 0.1, the produced multi-branched compound will have insufficient polyphenolic skeletons introduced therein and thus the resin having a desired molecular weight will not be obtained and, as a result, the resin undesirably fails to allow a coating film to have sufficient properties. Conversely, if the equivalent ratio mentioned above exceeds 1, the produced multi-branched compound will also have insufficient polyfunctional epoxy compound skeletons introduced therein and thus the resin having a desired molecular weight will not be obtained and, as a result, the resin undesirably fails to allow a coating film to have sufficient properties. By varying the reaction conditions such as the reaction time and the reaction temperature and by controlling the amount of the polyphenolic compound (b′) to be used in the range of the equivalent ratio mentioned above, it is possible to control the molecular weight and the branched state of the produced multi-branched compound to a certain extent.

Further, the ratio of the unsaturated monocarboxylic acid (c) to the polyfunctional epoxy compound (a) (the charging ratio in the reaction mixture) in a molar ratio of respective functional groups is desired to be in the range of 0.1≦[number of mols of the carboxyl group of the unsaturated monocarboxylic acid]/[number of mols of the epoxy group of the polyfunctional epoxy compound]≦10, more preferably in the range of 0.2≦[number of mols of the carboxyl group of the unsaturated monocarboxylic acid]/[number of mols of the epoxy group of the polyfunctional epoxy compound]≦5. The ratio of the compound (c′-1) which can react with a hydroxyl group, such as (meth)acryloyl halide or cyclic ethers containing an unsaturated double bond-containing group, to the polyfunctional epoxy compound (a) (the charging ratio in the reaction mixture) in a molar ratio of respective functional groups is desired to be in the range of 0.1≦[number of mols of the functional group of the compound which can react with a hydroxyl group, such as (meth)acryloyl halide or cyclic ethers containing an unsaturated double bond-containing group]/[number of mols of the epoxy group of the polyfunctional epoxy compound] ≦10, more preferably in the range of 0.2≦[number of mols of the carboxyl group of the compound which can react with a hydroxyl group, such as (meth)acryloyl halide or cyclic ethers containing an unsaturated double bond-containing group]/[number of mols of the epoxy group of the polyfunctional epoxy compound]≦5. Here, when the terminal group obtained after completion of the polyaddition reaction of the polyfunctional epoxy compound (a) with the polyphenolic compound (b′) is an epoxy group, merely the unsaturated monocarboxylic acid (c) may be used as a reaction terminator. When the terminal group is phenol, the compound (c′-1) which can react with a hydroxyl group, such as (meth)acryloyl halide or cyclic ethers containing an unsaturated double bond-containing group, may be used as a terminator. Further, when the terminal groups are the epoxy group and the phenolic hydroxyl group in combination, it is preferred that both the unsaturated monocarboxylic acid (c) and the compound (c′-1) which can react with a hydroxyl group, such as (meth)acryloyl halide or cyclic ethers containing an unsaturated double bond-containing group, be used as the terminator. The charging order in the synthesis is preferred to be firstly the unsaturated monocarboxylic acid (c) to consume the remaining epoxy group and then the compound (c′-1) which can react with a hydroxyl group, such as (meth)acryloyl halide or cyclic ethers containing an unsaturated double bond-containing group, to be condensed with or add to the phenolic hydroxyl group. In this way, it is possible to synthesize the unsaturated group-containing multi-branched compound (A-3) assuming a liquid state or a solid state depending on the size of the molecular weight.

The synthetic reactions and the conditions mentioned above directly apply to the syntheses of the unsaturated group-containing multi-branched compounds (A-2) and (A-4) of the present invention and the explanation thereof will be omitted because a person skilled in the art will easily understand them from the explanation described above.

Of the polyfunctional epoxy compounds (a) to be used in the present invention, the following compounds may be cited as the typical examples of the compound having two epoxy groups in its molecule.

For example, diglycidyl ethers and diglycidyl esters obtained by reacting epichlorohydrin and/or methyl epichlorohydrin with a bifunctional phenolic comound such as bisphenol A, bisphenol S, bisphenol F, tetrabromobisphenol A, biphenol, bixylenol, and naphthalene diol or a dicarboxylic acid such as adipic acid, phthalic acid, and hexahydrophthalic acid may be cited. An alicyclic epoxy compound obtained by oxidizing a cyclic olefin compound such as vinylcyclohexene with peracetic acid may also be cited. As the commercially available products, bisphenol A type epoxy resins represented by EPIKOTE 828, EPIKOTE 834, EPIKOTE 1001, and EPIKOTE 1004 produced by Japan Epoxy Resin Co., Ltd., DER-330 and DER-337 produced by The Dow Chemical Company, and YD-115, YD-128, YD-7011R, and YD-7017 produced by Tohto Kasei Co., Ltd.; bisphenol S type epoxy resins represented by DENAKOL EX-251 and DENAKOL EX-251A produced by Nagase Chemtex Corporation; bisphenol F type epoxy resins represented by YDF-170 produced by Tohto Kasei Co., Ltd.; tetrabromobisphenol A type epoxy resins represented by YDB-360, YDB-400 and YDB-405 produced by Tohto Kasei Co., Ltd.; resorcinol diglycidyl ethers represented by DENAKOL EX-201 produced by Nagase Chemtex Corporation; biphenol diglycidyl ethers represented by YX-4000 produced by Japan Epoxy Resin Co., Ltd.; naphthalene type epoxy resins represented by EPICLON HP-4032 and HP-4032D produced by Dainippon Ink and Chemicals Inc.; and phthalic diglycidyl esters represented by DENAKOL EX-721 produced by Nagase Chemtex Corporation, for example, may be cited. Further, alicyclic epoxy resins represented by Celloxide 2021 series, Celloxide 2080 series, and Celloxide 3000 produced by Daicel Chemical Industries, Ltd.; hydrogenated bisphenol A type epoxy resins represented by HBPA-DGE produced by Maruzen Petrochemical Co., Ltd. and YL-6663 produced by Japan Epoxy Resin Co., Ltd.; aliphatic epoxy resins represented by DENAKOL EX-212 and DENAKOL EX-701 produced by Nagase Chemtex Corporation; and other epoxy resins such as amino group-containing epoxy resins; copolymer type epoxy resins; and cardo type epoxy resins, for example, may be cited. These well known and widely used epoxy resins may be used either singly or in the form of a combination of two or more members.

As the typical examples of the compound having three epoxy groups in its molecule, the following compounds may be cited: for example, DENAKOL EX-301 produced by Nagase Chemtex Corporation and EPOLEAD GT400 produced by Daicel Chemical Industries, Ltd. As long as the compound has three epoxy groups in its molecule, any well known and widely used epoxy resins may be used either singly or in the form of a combination of two or more members without limitation. Further, the four or more functional epoxy compounds, such as cresol novolak type epoxy resin, may be used either singly or in the form of a combination of two or more members, though the branched state becomes more complex.

Of the polycarboxylic acids (b) to be used in the present invention, as the typical examples of the compound having two carboxyl groups in its molecule, dicarboxylic acids represented by the following general formula (17) may be cited.
HOOC—R²—COOH (17)

In the formula, R² represents the same meaning as mentioned above.

As concrete examples of the dicarboxylic acid, linear aliphatic dicarboxylic acids of 2 to 20 carbon atoms such as oxalic acid, malonic acid, succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, octadecanedioic acid, nonadecanedioic acid, and eicosanedioic acid; branched aliphatic dicarboxylic acids of 3 to 20 carbon atoms such as methyl malonic acid, ethyl malonic acid, n-propyl malonic acid, butyl malonic acid, methyl succinic acid, ethyl succinic acid, and 1,1,3,5-tetramethyl octyl succinic acid; linear or branched aliphatic unsaturated dicarboxylic acids such as maleic acid, fumaric acid, citraconic acid, methyl citraconic acid, mesaconic acid, methyl mesaconic acid, itaconic acid, and glutaconic acid; hexahydrophthalic acid, hexahydroisophthalic acid, hexahydroterephthalic acid, cyclohexene-1,2-dicarboxylic acid, cyclohexene-1,6-dicarboxylic acid, cyclohexene-3,4-dicarboxylic acid, cyclohexene-4,5-dicarboxylic acid, and tetrahydrophthalic acids such as methyl hexahydrophthalic acid, methyl hexahydroisophthalic acid, and methyl hexahydroterephthalic acid respectively represented by the following formula (18) may be cited.

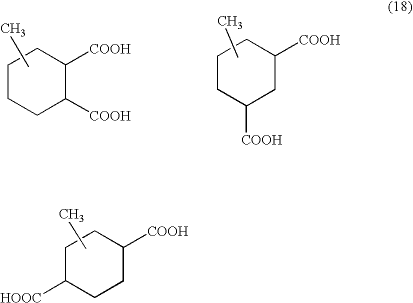

In addition thereto, tetrahydroisophthalic acids such as cyclohexene-1,3-dicarboxylic acid, cyclohexene-1,5-dicarboxylic acid, and cyclohexene-3,5-dicarboxylic acid; tetrahydroterephthalic acids such as cyclohexene-1,4-dicarboxylic acid and cyclohexene-3,6-dicarboxylic acid; dihydrophthalic acids such as 1,3-cyclohexadiene-1,2-dicarboxylic acid, 1,3-cyclohexadiene-1,6-dicarboxylic acid, 1,3-cyclohexadiene-2,3-dicarboxylic acid, 1,3-cyclohexadiene-5,6-dicarboxylic acid, 1,4-cyclohexadiene-1,2-dicarboxylic acid, and 1,4-cyclohexadiene-1,6-dicarboxylic acid; dihydroisophthalic acids such as 1,3-cyclohexadiene-1,3-dicarboxylic acid and 1,3-cyclohexadiene-3,5-dicarboxylic acid; dihydroterephthalic acids such as 1,3-cyclohexadiene-1,4-dicarboxylic acid, 1,3-cyclohexadiene-2,5-dicarboxylic acid, 1,4-cyclohexadiene-1,4-dicarboxylic acid, and 1,4-cyclohexadiene-3,6-dicarboxylic acid; and saturated or unsaturated alicyclic dicarboxylic acids such as methyl tetrahydrophthalic acid represented by the following formula (19), endomethylenetetrahydrophthalic acid, endo-cis-bicyclo[2.2.1]hepto-5-ene-2,3-dicarboxylic acid (product name: nadic acid), and methylendo-cis-bicyclo[2.2.1]hepto-5-ene-2,3-dicarboxylic acid (product name: methyl nadic acid) may also be cited.

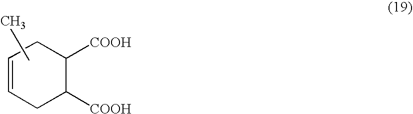

Furthermore, phthalic acid, isophthalic acid, terephthalic acid; 3-alkyl phthalic acids such as 3-methyl phthalic acid, 3-ethyl phthalic acid, 3-n-propyl phthalic acid, 3-sec-butyl phthalic acid, 3-isobutyl phthalic acid, and 3-tert-butyl phthalic acid; 2-alkyl isophthalic acids such as 2-methyl isophthalic acid, 2-ethyl isophthalic acid, 2-propyl isophthalic acid, 2-isopropyl isophthalic acid, 2-n-butyl isophthalic acid, 2-sec-butyl isophthalic acid, and 2-tert-butyl isophthalic acid; 4-alkyl isophthalic acids such as 4-methyl isophthalic acid, 4-ethyl isophthalic acid, 4-propyl isophthalic acid, 4-isopropyl isophthalic acid, 4-n-butyl isophthalic acid, 4-sec-butyl isophthalic acid, and 4-tert-butyl isophthalic acid; alkyl terephthalic acids such as methyl terephthalic acid, ethyl terephthalic acid, propyl terephthalic acid, isopropyl terephthalic acid, n-butyl terephthalic acid, sec-butyl terephthalic acid, and tert-butyl terephthalic acid; and aromatic dicarboxylic acids such as naphthalene-1,2-dicarboxylic acid, naphthalene-1,3-dicarboxylic acid, naphthalene-1,4-dicarboxylic acid, naphthalene-1,5-dicarboxylic acid, naphthalene-1,6-dicarboxylic acid, naphthalene-1,7-dicarboxylic acid, naphthalene-1,8-dicarboxylic acid, naphthalene-2,3 -dicarboxylic acid, naphthalene-2,7-dicarboxylic acid, anthracene-1,3-dicarboxylic acid, anthracene-1,4-dicarboxylic acid, anthracene-1,5-dicarboxylic acid, anthracene-1,9-dicarboxylic acid, anthracene-2,3-dicarboxylic acid, and anthracene-9,10-dicarboxylic acid may be cited.

Further, in the present invention the dicarboxylic acids represented by the following general formula (20) may be used besides the dicarboxylic acids enumerated above.

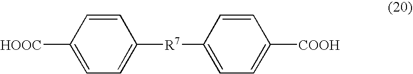

In the formula, R⁷ represents —O—, —S—, —CH₂—, —NH—, —SO₂—, —CH(CH₃)—, —C(CH₃)₂—, or —C(CF₃)₂—.

As the typical examples of the compound (b) having at least three carboxyl groups in its molecule, tricarboxylic acids represented by the following general formula (21) may be cited.

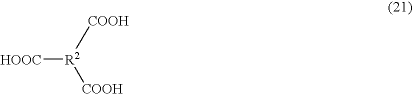

As the concrete examples of the tricarboxylic acid, saturated or unsaturated aliphatic tricarboxylic acids having 1 to 18 carbon atoms such as methane tricarboxylic acid, 1,2,3-propane tricarboxylic acid, 1,3,5-pentane tricarboxylic acid, aconitic acid, and 3-butene-1,2,3-tricarboxylic acid, and aromatic tricarboxylic acids such as hemimellitic acid, trimesic acid, and trimellitic acid may be cited.

Further, tricarboxylic acids represented by the following general formula (22) may also be cited.

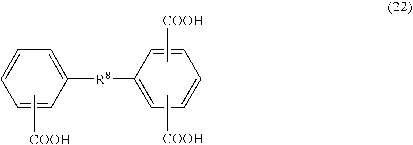

In the formula, R⁸ represents —O—, —S—, —CH₂—, —NH—, —SO₂—, —CH(CH₃)—, —C(CH₃)₂—, or —C(CF₃)₂—.

Moreover, tricarboxylic acids represented by the following general formula (23) may also be cited.

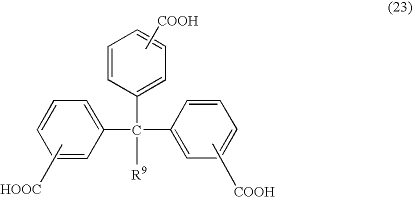

In the formula, R⁹ represents an alkyl group of 1 to 12 carbon atoms, an aryl group, or an aralkyl group.

Furthermore, tricarboxylic acids having an isocyanuric acid skeleton and represented by the following general formulas (24) and (25) may also be cited.

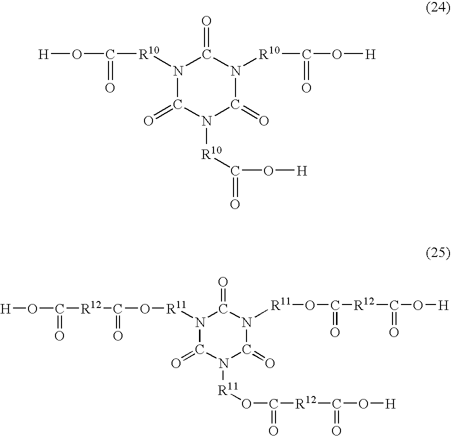

In the formulas, R¹⁰ and R¹¹ independently represent a hydrocarbon group of 1 to 4 carbon atoms, and R¹² represents a hydrocarbon group of 2 to 20 carbon atoms.

As the tricarboxylic acids having an isocyanuric acid skeleton and represented by the general formula (24) mentioned above, for example, tris(2-carboxyethyl)isocyanurate, tris(3-carboxypropyl)isocyanurate, etc. may be cited. As the tricarboxylic acids having an isocyanuric acid skeleton and represented by the general formula (25) mentioned above, for example, the compounds of tris(2-carboxyethyl)isocyanurate added with a dibasic acid anhydride such as phthalic anhydride, succinic anhydride, octenylphthalic anhydride, pentadodecenylsuccinic anhydride, maleic anhydride, tetrahydrophthalic anhydride, hexahydrophthalic anhydride, methyltetrahydrophthalic anhydride, 3,6-endomethylenetetrahydrophthalic anhydride, methylendomethylenetetrahydrophthalic anhydride, tetrabromophthalic anhydride, 3,6 -endomethylenetetrahydrophthalic anhydride, methylendomethylenetetrahydrophthalic anhydride, and tetrabromophthalic anhydride may be cited. Further, the four or more functional polycarboxylic acids may be used, though the branched state becomes more complex.

Of the polyphenolic compounds (b′) to be used in the present invention, as the typical examples of the compound having two hydroxyl groups in its molecule, for example, catechol, 1,1′-bisphenyl-4,4′-diol, methylene bisphenol, 4,4′-ethylidene bisphenol, 2,2′-methylidene bis(4-methylphenol), 4,4′-methylidene bis(2,6-dimethylphenol), 4,4′-(1-methyl-ethylidene) bis(2-methylphenol), 4,4′-cyclohexylidene bisphenol, 4,4′-(1,3-dimethylbutylidene)bisphenol, 4,4′-(1-methylethylidene) bis(2,6-dimethylphenol), 4,4′-(1-phenylethylidene) bisphenol, 5,5′-(1-methylethylidene) bis(1,1′-biphenyl-2-ol), 4,4′-oxybisphenol, bis(4-hydroxyphenyl)methanone, 2,2′-methylene bisphenol, 3,5,3′,5′-tetramethylbiphenyl-4,4′-diol, 4,4′-isopropylidene diphenol, and 4,4′-methylene bis(2,6-dibromophenol) may be cited. These well known and widely used bifunctional phenolic compounds may be used either singly or in the form of a combination of two or more members.

As the typical examples of the compound having three hydroxyl groups in its molecule, for example, pyrogallol, 4,4′,4″-methylidene trisphenol, 4,4′-(1-(4-(1-(4-hydroxy phenyl)-1-methylethyl)phenyl)ethylidene)bisphenol, (2,3,4-trihydroxyphenyl)(4′-hydroxy phenyl)methanone, and 2,6-bis(2-hydroxy-5-methylphenyl methyl)-4-methyl phenol may be cited. These well known and widely used trifunctional phenolic compounds may be used either singly or in the form of a combination of two or more members. Further, four or more functional phenolic compounds may be used either singly or in the form of a combination of two or more members, though the branched state becomes more complex.

Further, as the compound (b″) containing at least one of carboxyl group and phenolic hydroxyl group severally in its molecule, salicylic acid, p-hydroxybenzoic acid, p-hydroxyphenyl acetic acid, p-hydroxyphenyl propionic acid, 3-hydroxy-2-naphthoic acid, 6-hydroxy-2-naphthoic acid, 4-hydroxybiphenyl-4′-carboxylic acid, 1,4-dihydroxy-2-naphthoic acid, and 5-hydroxyisophthalic acid, etc. may be cited. These compounds may be used either singly or in the form of a combination of two or more members.

As the unsaturated monocarboxylic acid (c) to be used in the reaction mentioned above, any known compounds containing a polymerizable unsaturated group and a carboxylic group in combination in its molecule may be used. As concrete examples thereof, acrylic acid, methacrylic acid, cinnamic acid, crotonic acid, sorbic acid, α-cyanocinnamic acid, β-styryl acrylic acid, etc. may be cited. Alternatively, a half ester of a dibasic acid anhydride with a (meth)acrylate having a hydroxyl group may be used. As concrete examples, the half esters of an acid anhydride such as phthalic acid, tetrahydrophthalic acid, hexahydrophthalic acid, maleic acid, and succinic acid with a hydroxyl group-containing (meth)acrylate such as hydroxyethyl acrylate, hydroxyethyl methacrylate, hydroxypropyl acrylate, and hydroxypropyl methacrylate may be cited. Further, the compounds obtained by adding lactone monomer such as ε-caprolactone to these compounds may be cited. These unsaturated monocarboxylic acids may be used either singly or in the form of a combination of two or more members. Incidentally, the term “(meth)acrylate” as used in the present specification refers collectively to acrylate and methacrylate. This holds good for other similar expression.

As the compound (c′) having at least one unsaturated double bond-containing group, any compound may be used without limitation as long as it has a reactive group which can react with a carboxyl group or a phenolic hydroxyl group and an unsaturated double bond-containing group as well. For example, well known and widely used compounds such as unsaturated monocarboxylic acids mentioned above, unsaturated acid halides like acrylic chloride and methacrylic chloride, and unsaturated group-containing cyclic ethers like glycidyl methacrylate may be cited. As the examples of the unsaturated monocarboxylic acid, acrylic acid, methacrylic acid, cinnamic acid, crotonic acid, sorbic acid, α-cyanocinnamic acid, β-styryl acrylic acid, etc. may be cited. Alternatively, a half ester of a dibasic acid anhydride with a (meth)acrylate having a hydroxyl group may be used. As concrete examples, the half esters of an acid anhydride such as phthalic acid, tetrahydrophthalic acid, hexahydrophthalic acid, maleic acid, and succinic acid with a hydroxyl group-containing (meth)acrylate such as hydroxyethyl acrylate, hydroxyethyl methacrylate, hydroxypropyl acrylate, and hydroxypropyl methacrylate may be cited. Further, the compounds obtained by adding lactone monomer such as ε-caprolactone to these compounds may be cited. When the terminal is a carboxyl group, however, unsaturated acid halides such as acrylic chloride and methacrylic chloride prove to be undesirable in view of poor storage stability.

As a reaction accelerator to be used in the syntheses of the unsaturated group-containing multi-branched compounds (A-1) to (A-4) mentioned above, any compound may be arbitrarily selected from among a tertiary amine, a tertiary amine salt, a quaternary onium salt, a tertiary phosphine, a crown ether complex, and a phosphonium ylide. These compounds may be used either singly or in the form of a combination of two or more members.

As the tertiary amine, triethylamine, tributylamine, DBU (1,8-diazabicyclo[5.4.0]undeca-7-ene), DBN (1,5-diazabicyclo[4.3.0]nona-5-ene), DABCO (1,4-diazabicyclo[2.2.2]octane), pyridine, N,N-dimethyl-4-amino pyridine, etc. may be cited.

As the tertiary amine salt, U-CAT series of Sun-Apro K.K., for example, may be cited.

As the quaternary onium salt, ammonium salts, phosphonium salts, arsonium salts, stibonium salts, oxonium salts, sulfonium salts, selenonium salts, stannonium salts, iodonium salts, etc. may be cited. Particularly preferable salts are ammonium salts and phosphonium salts. As concrete examples of the ammonium salts, tetra-n-butylammonium halides such as tetra-n-butylammonium chloride (TBAC), tetra-n-butylammonium bromide (TBAB), and tetra-n-butylammonium iodide (TBAI), and tetra-n-butylammonium acetate (TBAAc) may be cited. As concrete examples of the phosphonium salts, tetra-n-butylphosphonium halides such as tetra-n-butylphosphonium chloride (TBPC), tetra-n-butylphosphonium bromide (TBPB), and tetra-n-butylphosphonium iodide (TBBI), tetraphenylphosphonium halides such as tetraphenylphosphonium chloride (TPPC), tetraphenylphosphonium bromide (TPPB), and tetraphenylphosphonium iodide (TPPI), and ethyltriphenylphosphonium bromide (ETPPB), ethyltriphenylphosphonium acetate (ETPPAc), etc. may be cited.

As the tertiary phosphine, any trivalent organic phosphorus compounds containing an alkyl group of 1 to 12 carbon atoms or an aryl group may be used. As the concrete examples thereof, triethylphosphine, tributylphosphine, triphenylphosphine, etc. may be cited.

Further, a quaternary onium salt formed by the addition reaction of a tertiary amine or a tertiary phosphine with a carboxylic acid or a highly acidic phenol may be used as the reaction accelerator. They may be in the form of a quaternary salt before adding to the reaction system. Alternatively, they may be individually added to the reaction system so as to form the quaternary salt in the reaction system. As the concrete examples thereof, tributylamine acetate obtained from tributylamine and acetic acid and triphenylphosphine acetate formed from triphenylphosphine and acetic acid may be cited.

As concrete examples of the crown ether complex, complexes of crown ethers such as 12-crown-4,15-crown-5,18-crown-6, dibenzo-18-crown-6,21-crown-7, and 24-crown-8 with alkali metal salts such as lithium chloride, lithium bromide, lithium iodide, sodium chloride, sodium bromide, sodium iodide, potassium chloride, potassium bromide, and potassium iodide may be cited.

Although any known compounds obtained by the reaction of a phosphonium salt and a base may be used as the phosphonium ylide, a highly stable compound is preferable from the viewpoint of easy handling. As concrete examples thereof, (formylmethylene)triphenylphosphine, (acetylmethylene)triphenylphosphine, (pivaloylmethylene)triphenylphosphine, (benzoylmethylene)triphenylphosphine, (p-methoxybenzoylmethylene)triphenylphosphine, (p-methylbenzoylmethylene)triphenylphosphine, (p-nitrobenzoylmethylene)triphenylphosphine, (naphthoyl)triphenylphosphine, (methoxycarbonyl)triphenylphosphine, (diacetylmethylene)triphenylphosphine, (acetylcyano)triphenylphosphine, (dicyanomethylene)triphenylphosphine, etc. may be cited.

The amount of the reaction accelerator to be used is preferred to be in the approximate range of 0.0.1 to 25 mol %, more preferably 0.5 to 20 mol %, most preferably 1 to 15 mol %, based on one mol of the epoxy group of the polyfunctional epoxy compound (a). If the amount of the reaction accelerator to be used is less than 0.1 mol % based on one mol of the epoxy group, the reaction will not proceed at a practical reaction speed. Conversely, a large amount exceeding 25 mol % is not desirable from the economical viewpoint because a remarkable reaction acceleration effect will not be obtained even when the accelerator is present in such a large amount.

The reaction temperature in the syntheses of the unsaturated group-containing multi-branched compounds (A-1) to (A-4) mentioned above is preferred to be in the approximate range of 50 to 200° C., more preferably 70 to 130° C. If the reaction temperature is lower than 50° C., the reaction will not proceed to a satisfactory extent. Conversely, the reaction temperature exceeding 200° C. is not desirable from the reasons that the reaction products will tend to cause the thermal polymerization due to the reaction of the double bonds thereof and that the unsaturated monocarboxylic acid having a low boiling point will evaporate. Although the reaction time may be suitably selected depending on the reactivity of the raw materials to be used and the reaction temperature, the preferred reaction time is about 5 to about 72 hours.

Although the aforementioned reaction proceeds in the absence of a solvent, the reaction may also be performed in the presence of a diluent (D) for the purpose of improving the agitating effect during the reaction. Although the diluent (D) to be used is not limited to a particular one insofar as it can keep the reaction temperature, the diluents which can dissolve the raw materials therein prove to be desirable. When an organic solvent (D-1) is used as the diluent (D) during the synthesis, the solvent may be removed by a well known method such as vacuum distillation. Furthermore, the production may also be carried out in the presence of a reactive diluent (D-2) to be described hereinafter.

As the organic solvent (D-1), any known organic solvents may be used insofar as they will not exert a harmful influence on the reaction and can keep the reaction temperature. As concrete examples thereof, alcohols such as diethylene glycol monomethyl ether, diethylene glycol monoethyl ether, dipropylene glycol monomethyl ether, and dipropylene glycol monobutyl ether; glycol esters such as ethylene glycol monomethyl ether acetate, diethylene glycol monomethyl ether acetate, diethylene glycol monoethyl ether acetate, propylene glycol monomethyl ether acetate, propylene glycol monoethyl ether acetate, propylene glycol monobutyl ether acetate, and dipropylene glycol monomethyl ether acetate; ethers such as diethylene glycol dimethyl ether and dipropylene glycol dimethyl ether; ketones such as methylisobutyl ketone and cyclohexanone; amides such as dimethylfbrmamide, dimethylacetamide, N-methylpyrrolidone, and hexamethylphosphoric triamide; and hydrocarbons such as toluene and xylene may be cited. However, alcohols mentioned above may not be used as a solvent for the syntheses of the unsaturated group-containing multi-branched compounds (A-5) to (A-8) during the addition of a polybasic acid anhydride to be described hereinbelow.

Next, the syntheses of the unsaturated group-containing multi-branched compounds (A-5) to (A-8) will be described below.

The unsaturated group-containing multi-branched compounds (A-5) to (A-8) having a carboxyl group are produced by causing 0.1 to 1.0 mol of a polybasic acid anhydride (d) to react with one mol of the hydroxyl group of the unsaturated group-containing multi-branched compounds (A-1) to (A-4) produced as described above and having ethylenically unsatureated groups in their terminals and secondary hydroxyl groups in their side chains. Since the secondary hydroxyl groups caused by the addition reaction of the epoxy groups of the polyfunctional epoxy compound (a) with the carboxyl groups or phenolic hydroxyl groups of the polycarboxylic acid or polyphenolic compound (b) are present in the unsaturated group-containing multi-branched compounds (A-1) to (A-4) mentioned above and the carboxyl group is introduced into the multi-branched compound by the addition reaction of this hydroxyl group with the polybasic acid anhydride (d), the resultant unsaturated group-containing multi-branched compounds (A-5) to (A-8) become soluble in an aqueous alkaline solution.

As concrete examples of the polybasic acid anhydrides (d), dibasic or tribasic acid anhydrides such as phthalicanhydride, succinic anhydride, octenylphthalic anhydride, pentadodecenylsuccinic anhydride, maleic anhydride, tetrahydrophthalic anhydride, hexahydrophthalic anhydride, methyltetrahydrophthalic anhydride, 3,6-endomethylenetetrahydrophthalic anhydride, methylendomethylenetetrahydrophthalic anhydride, tetrabromophthalic anhydride, and trimellitic anhydride; and tetrabasic acid dianhydrides such as biphenyl-tertacarboxylic dianhydride, naphthalene-tertacarboxylic dianhydride, diphenyl ether-tertacarboxylic dianhydride, cyclopentane-tertacarboxylic dianhydride, pyromellitic anhydride, and benzophenone-tetracarboxylic dianhydride may be cited. These polybasic acid anhydrides may be used either singly or in the form of a mixture of two or more members.

Each reaction of the above polybasic acid anhydride (d) with the unsaturated group-containing multi-branched compounds (A-1) to (A-4) mentioned above may be performed at a temperature in the approximate range of 50 to 150° C., preferably 80 to 130° C. in a mixing ratio mentioned above. The amount of the polybasic acid anhydride (d) to be used is preferred to be in the range of 0.1 to 1.0 mol per one mol of the hydroxyl group of the unsaturated group-containing multi-branched compounds (A-1) to (A-4) mentioned above. The amount of the polybasic acid anhydride lower than 0.1 mol is not preferable from the reason that the amount of the carboxyl group introduced in the multi-branched compound is too small and thus alkali-solubility of the multi-branched compound will considerably decreases. Conversely, an unduly large amount exceeding 1.0 mol is not preferable because the unreacted polybasic acid anhydride (d) remains in the resin and it will deteriorate the properties of the resin such as durability and electrical insulation properties.

In the reaction of the polybasic acid anhydride (d) mentioned above, a reaction accelerator such as a tertiary amine, a tertiary amine salt, a quaternary onium salt, a tertiary phosphine, a phosphonium ylide, a crown ether complex, and an adduct of a tertiary amine or a tertiary phosphine with a carboxylic acid or a highly acidic phenol may be used. The amount of the reaction accelerator to be used is preferred to be in the range of 0.1 to 25 mol %, preferably 0.5 to 20 mol %, most preferably 1 to 15 mol %, based on one mol of the polybasic acid anhydride. If the catalyst used for the production of the unsaturated group-containing multi-branched compounds (A-1) to (A-4) mentioned above still remains in the system, however, the reaction will be promoted even if the catalyst is not newly added.

Although the aforementioned reaction proceeds either in the presence of an organic solvent (D-1) or in the absence of a solvent, the reaction may also be performed in the presence of the aforementioned diluent (D) for the purpose of improving the agitating effect during the reaction.

In the aforementioned reaction, air blowing or the addition of a polymerization inhibitor may be done for the purpose of preventing the reaction mixture from gelation due to polymerization of the unsaturated double bonds. As the examples of the polymerization inhibitor, hydroquinone, toluquinone, methoxyphenol, phenothiazine, triphenyl antimony, copper chloride, etc. may be cited.

The unsaturated group-containing multi-branched compounds of the present invention, as occasion demands, may be subjected to the following modifications, for example.

(1) An epihalohydrin such as, for example, epichlorohydrin is caused to react with a part or the whole of the secondary hydroxyl groups resulting from the reaction of the polyfunctional epoxy compound (a) with the polycarboxylic acid (b) or polyphenolic compound (b′) to polyepoxidize the reaction product and then the unsaturated monocarboxylic acid (c) is caused to react with the resultant product.

(2) An isocyanate group-containing (meth)acrylate such as, for example, an equimolar reaction product of isophorone diisocyanate and pentaerythritol triacrylate is caused to react with a part or the whole of the secondary hydroxyl groups resulting from the reaction of the polyfunctional epoxy compound (a) with the polycarboxylic acid (b) or polyphenolic compound (b′) and then the unsaturated monocarboxylic acid (c) is caused to react with the resultant product.

(3) A halogenated alkyl compound such as, for example, benzyl chloride is caused to react with a part or the whole of the secondary hydroxyl groups resulting from the reaction of the polyfunctional epoxy compound (a) with the polycarboxylic acid (b) or polyphenolic compound (b′) and then the unsaturated monocarboxylic acid (c) is caused to react with the resultant product.

By mixing the unsaturated group-containing multi-branched compound (either one or a mixture of two or more of (A-1) to (A-8)) of the present invention obtained as described above with a photo-radical polymerization initiator and/or a heat radical polymerization initiator as the polymerization initiator (B), a photocurable and/or thermosetting composition may be obtained. This composition cures promptly by irradiation of an actinic energy ray such as an ultraviolet ray or an electron beam or further cures by heating and allows formation of a cured product excelling in adhesiveness to a substrate, mechanical properties, resistance to chemicals, etc.

Further, by mixing the unsaturated group-containing multi-branched compound (either one or a mixture of two or more of (A-1) to (A-8)) mentioned above and a polymerization initiator (B) with a thermosetting component (C), for example, a compound containing at least two epoxy groups and/or oxetanyl groups in its molecule, a photocurable and thermosetting composition may be obtained. This photocurable and thermosetting composition is capable of forming an image by subjecting its coating film to exposure to light and development and allows formation of a cured film excelling in various properties such as adhesiveness to a substrate, mechanical properties, resistance to heat, electrical insulation properties, resistance to chemicals, and resistance to cracks by the heating of the coating film after development, without causing any shrinkage on curing.

Moreover, by adding a reactive monomer to be described hereinafter as the diluent (D) to the curable composition or the photocurable and thermosetting composition mentioned above, it is possible to improve the photocuring properties thereof. Incidentally, the amount of the unsaturated group-containing multi-branched compound (either one or a mixture of two or more of (A-1) to (A-8)) to be incorporated in the curable composition or the photocurable and thermosetting composition of the present invention is not limited to a particular range.

As the photo-radical polymerization initiator to be used as the polymerization initiator (B) mentioned above, any known compounds which generate radicals by irradiation of an actinic energy ray may be used. As concrete examples thereof, benzoin and alkyl ethers thereof such as benzoin, benzoin methyl ether, and benzoin ethyl ether; acetophenones such as acetophenone, 2,2-dimethoxy-2-phenyl acetophenone and 4-(1-t-butyldioxy-1-methylethyl) acetophenone; anthraquinones such as 2-methylanthraquinone, 2-amylanthraquinone, 2-t-butyl anthraquinone, and 1-chloroanthraquinone; thioxanthones such as 2,4-dimethylthioxanthone, 2,4-diisopropylthioxanthone, and 2-chlorothioxanthone; ketals such as acetophenone dimethyl ketal and benzyl dimethyl ketal; benzophenones such as benzophenone, 4-(1-t-butyldioxy-1-methylethyl)benzophenone, and 3,3′,4,4′-tetrakis(t-butyldioxycarbonyl)benzophenone; aminoacetophenones such as 2-methylthio-1-[4-(methylthio)phenyl]-2-morpholino-propane-1-one and 2-benzyl-2-dimethylamino-1-(4-morpholinophenyl)-butane-1-one; alkylphosphines such as 2,4,6-trimethylbenzoyl phosphine oxide; and acryzines such as 9-phenyl acryzine may be cited.

These photo-radical polymerization initiators may be used either singly or in the form of a combination of two or more members. The amount of the photo-radical polymerization initiator to be used is preferred to be in the range of from 0.1 to 30 parts by weight, based on 100 parts by weight of the unsaturated group-containing multi-branched compound (either one or a mixture of two or more of (A-1) to (A-8)) mentioned above. If the amount of the photo-radical polymerization initiator to be used is less than the lower limit of the range mentioned above, the composition will not be photocured by irradiation of an actinic energy ray or the irradiation time should be prolonged, and a coating film of satisfactory properties will be obtained only with difficulty. Conversely, even if the photo-radical polymerization initiator is added to the composition in a large amount exceeding the upper limit of the range mentioned above, the composition will not attain the further improvement in the curing properties and such a large amount is not desirable from the economical viewpoint.

In the curable composition or the photocurable and thermosetting composition of the present invention, for the purpose of improving the curing with an actinic energy ray, a curing accelerator and/or sensitizer may be used in combination with the photo-radical polymerization initiator mentioned above. As the curing accelerators which are usable herein, tertiary amines such as triethylamine, triethanolamine, 2-dimethylaminoethanol, N,N-(dimethylamino)ethyl benzoate, N,N-(dimethylamino)isoamyl benzoate, and pentyl-4-dimethylamino benzoate; and thioethers such as 3-thiodiglycol may be cited. As the sensitizer, sensitizing dyestuff such as (keto)cumalin and thioxantene; and alkyl borates of such dyestuff as cyanine, rhodamine, safranine, malachite green, and methylene blue may be cited. These curing accelerators and/or sensitizers may be used independently either singly or in the form of a combination of two or more members. The amount of the curing accelerators and/or sensitizers to be used is preferred to be in the range of from 0.1 to 30 parts by weight, based on 100 parts by weight of the unsaturated group-containing multi-branched compound (either one or a mixture of two or more of (A-1) to (A-8)) mentioned above.

As the heat radical polymerization initiator to be used as the polymerization initiator (B) mentioned above, organic peroxides such as benzoyl peroxide, acetyl peroxide, methyl ethyl ketone peroxide, lauroyl peroxide, dicumyl peroxide, di-t-butyl peroxide, t-butyl hydroperoxide, and cumene hydroperoxide; and azo type initiators such as 2,2′-azobisisobutyronitrile, 2,2′-azobis-2-methylbutyronitrile, 2,2′-azobis-2,4-divaleronitrile, 1,1′-azobis(1-acetoxy-1-phenylethane), 1′-azobis-1-cyclohexane carbonitrile, dimethyl-2,2′-azobisisobutylate, 4,4′-azobis-4-cyanovalic acid, and 2-methyl-2,2′-azobispropanenitrile may be cited. As the preferred initiator, 1,1′-azobis(1-acetoxy-1-phenylethane) of the non-cyane and non-halogen type may be cited. The heat radical polymerization initiator may be used in the proportion of 0.1 to 10 parts by weight, preferably 0.5 to 5 parts by weight, based on 100 parts by weight of the unsaturated group-containing multi-branched compound (either one or a mixture of two or more of (A-1) to (A-8)) mentioned above.

When an organic peroxide which exhibits a lower curing rate is used as the heat radical polymerization initiator, tertiary amines such as tributylamine, triethylamine, dimethyl-p-toluidine, dimethylaniline, triethanolamine, and diethanolamine, or metallic soap such as cobalt naphthenate, cobalt octoate, and manganous naphthenate may be used as a accelerator.

As the thermosetting component (C) to be added to the photocurable and thermosetting composition of the present invention, a polyfunctional epoxy compound (C-1) and/or a polyfunctional oxetane compound (C-2) containing at least two epoxy groups and/or oxetanyl groups in its molecule may be advantageously used.

As the polyfunctional epoxy compound (C-1), any known and widely used epoxy resins, for example, novolak type epoxy resins (such as, for example, those which are obtained by causing such phenols as phenol, cresol, halogenated phenols, and alkyl phenols to react with formaldehyde in the presence of an acidic catalyst and then causing the resultant novolaks to react with epichlorohydrin and/or methyl epichlorohydrin and which include such commercially available substances as EOCN-103, EOCN-104S, EOCN-1020, EOCN-1027, EPPN-201, and BREN-S produced by Nippon Kayaku Co., Ltd., DEN-431 and DEN-438 produced by The Dow Chemical Company, N-730, N-770, N-865, N-665, N-673, N-695, and VH-4150 produced by Dainippon Ink and Chemicals, Inc.), bisphenol A type epoxy resins (such as, for example, those which are obtained by causing such a bisphenol A compound as bisphenol A and tetrabromobisphenol A to react with epichlorohydrin and/or methyl epichlorohydrin and which include such commercially available substances as EPIKOTE 1004 and EPIKOTE 1002 produced by Japan Epoxy Resin K.K. and DER-330 and DER-337 produced by The Dow Chemical Company), trisphenol methane type epoxy resins (such as, for example, those which are obtained by causing trisphenol methane, triscresol methane, etc. to react with epichlorohydrin and/or methyl epichlorohydrin and which include such commercially available substances as EPPN-501 and EPPN-502 produced by Nippon Kayaku Co., Ltd.), tris(2,3-epoxypropyl)isocyanurate, biphenol diglycidyl ether, and other epoxy resins such as alicyclic epoxy resins, amino group-containing epoxy resins, copolymer type epoxy resins, cardo type epoxy resins, and calixarene type epoxy resins may be used either singly or in the form of a combination of two or more members.

As the polyfunctional oxetane compounds (C-2) to be used in the photocurable and thermosetting composition of the present invention, bisoxetanes containing two oxetane rings in their molecules and trisoxetanes etc. containing three or more oxetane rings in their molecules may be cited. These oxetanes may be used either singly or in the form of a combination of two or more members.

The amount of the polyfunctional epoxy compound (C-1) and/or polyfunctional oxetane compound (C-2) mentioned above to be incorporated in the composition is desired to be in the range of 5 to 100 parts by weight, preferably 15 to 60 parts by weight, based on 100 parts by weight of the unsaturated group-containing multi-branched compound (either one or a mixture of two or more of (A-1) to (A-8)) mentioned above.

Further, for the purpose of accelerating the thermal curing reaction, a small amount of a well-known curing accelerator such as tertiary amines, quaternary onium salts, tertiary phosphines, crown ether complex, imidazole derivatives and dicyandiamide may be used together. The curing accelerator may be arbitrarily selected from among these compounds and may be used either singly or in the form of a combination of two or more members. Besides, other known curing accelerators such as a phosphonium ylide may be used.

As the imidazole derivatives, imidazole, 2-methylimidazole, 2-ethylimidazole, 2-ethyl-4-methylimidazole, 2-phenylimidazole, 4-phenylimidazole, 1-cyanoethyl-2-phenylimidazole, 1-cyanoethyl-2-ethyl-4-methylimidazole, etc. may be cited. The compounds which are commercially available include products of Shikoku Chemicals Co., Ltd., 2MZ-A, 2MZ-OK, 2PHZ, 2P4BHZ, and 2P4 MHZ. As the compounds which can improve the stability with time, the products of Asahi-Ciba Co., Ltd., Novacure HX-3721, HX-3748, HX-3741, HX-3088, HX-3722, HX-3742, HX-3921HP, HX-3941HP, HX-3613, etc. may be cited.

The amount of the curing accelerator to be used is preferred to be in the range of 0.1 to 25 mol %, more preferably 0.5 to 20 mol %, most preferably 1 to 15 mol %, based on one mol of the epoxy group and/or oxetanyl group of the polyfunctional epoxy compound (C-1) and/or polyfunctional oxetane compound (C-2) mentioned above. If the amount of the curing accelerator to be used is less than 0.1 mol per one mol of the epoxy group and/or oxetanyl group, the reaction will not proceed at a practical reaction speed. Conversely, a large amount exceeding 25 mol % is not desirable from the economical viewpoint because a remarkable reaction acceleration effect will not be obtained even when the accelerator is present in such a large amount.

To the curable composition or the photocurable and thermosetting composition of the present invention, a diluent (D) may be added during the synthesis or after the synthesis. As the diluent (D), a compound having a polymerizable group which is capable of taking part in the curing reaction may be advantageously used besides an organic solvent (D-1) mentioned above. Any known reactive diluents (D-2) such as monofunctional (meth)acrylates and/or polyfunctional (meth)acrylates may be used. As concrete examples thereof, methyl(meth)acrylate, ethyl(meth)acrylate, n-propyl (meth)acrylate, isopropyl(meth)acrylate, n-butyl (meth)acrylate, isobutyl(metha)crylate, 2-ethylhexyl (meth)acrylate, isodecyl(meth)acrylate, lauryl (meth)acrylate, tridecyl(meth)acrylate, stearyl (meth)acrylate, methoxypolyethylene glycol (meth)acrylate, cyclohexyl(meth)acrylate, tetrahydrofurfuryl (meth)acrylate, isobornyl(meth)acrylate, benzyl (meth)acrylate, 2-hydroxyethyl(meth)acrylate, 2 -hydroxypropyl(meth)acrylate, 2-hydroxybutyl(meth)acrylate, dimethylaminoethyl(meth)acrylate, ethylene glycol di(meth)acrylate, diethylene qlycol di(meth)acrylate, 1,4-butanediol di(meth)acrylate, 1,6-hexanediol di(meth)acrylate, trimethylol propane tri(meth)acrylate, glycerin di(meth)acrylate, pentaerythritol di(meth)acrylate, pentaerythritol tetra(meth)acrylate, dipentaerythritol hexa(meth)acrylate, polyester acrylate, reaction products of a dibasic acid anhydride with an alcohol having one or more unsaturated groups in its molecule, etc. may be cited. These reactive diluents (D-2) may be used either singly or in the form of a mixture of two or more members. Although the amount of the reactive diluent to be used is not limited to a particular range, it is preferred to be not more than 70 parts by weight, more preferably in the range of 5 to 40 parts by weight, based on 100 parts by weight of the total amount of the unsaturated group-containing multi-branched compounds (either one or a mixture of two or more of (A-1) to (A-8)) mentioned above.

The curable composition or the photocurable and thermosetting composition of the present invention may further incorporate therein, as desired, a well-known and widely used filler such as barium sulfate, silica, talc, clay, and calcium carbonate, a well-known and widely used coloring pigment such as phthalocyanine blue, phthalocyanine green, and carbon black, and various additives such as an anti-foaming agent, an adhesiveness-imparting agent, and a leveling agent.

The curable composition or the photocurable and thermosetting composition obtained as described above, after adjusting its viscosity by addition of a diluent, is applied to a substrate by a suitable coating method such as a screen printing method, a curtain coating method, a roll coating method, a dip coating method, and a spin coating method, and predried at a temperature in the approximate range of 60 to 120° C., for example, thereby to evaporate the organic solvent from the composition and give rise to a coating film. When the composition is in the form of a dry film, it may be laminated as it is. Thereafter, the coating film cures promptly by irradiation of an actinic energy ray.

In the case of the composition which comprises as a phtocurable component the unsaturated group-containing multi-branched compound having a carboxyl group, a resist pattern may be formed by selectively irradiating the coating film with an actinic energy ray through a photomask having a prescribed exposure pattern or by exposing the coating film to light by a direct imaging method and developing the unexposed areas of the coating film with an aqueous alkaline solution.

Further, in the case of the photocurable and thermosetting composition containing a thermosetting component, by thermally curing the film which had undergone the exposure to light and development mentioned above by subjecting it to the heat treatment at a temperature in the approximate range of 140 to 200° C., it is possible to form a cured film excelling in various properties such as adhesiveness, mechanical properties, resistance to soldering heat, resistance to chemicals, electrical insulation properties, and resistance to electrolytic corrosion. Furthermore, it is possible to further improve the various properties of the cured film by effecting the post UV curing before or after the thermal curing.

As an aqueous alkaline solution to be used in the process of development mentioned above, aqueous solutions of sodium hydroxide, potassium hydroxide, sodium carbonate, potassium carbonate, sodium silicate, ammonia, organic amines, tetramethylammonium hydroxide, etc. may be used. The concentration of an alkali in the developing solution may be proper generally in the range of 0.1 to 5.0 wt. %. As the developing method, various known methods such as dipping development, paddling development, and spraying development may be adopted.

The sources for irradiation which are properly used for the purpose of curing the curable composition or the photocurable and thermosetting composition mentioned above include a low-pressure mercury lamp, a medium-pressure mercury lamp, a high-pressure mercury lamp, an ultra-high-pressure mercury lamp, a xenon lamp, and a metal halide lamp, for example. Laser beams may also be utilized as the actinic light source for exposure. Further, electron beams, α-rays, β-rays, γ-rays, X-rays, neutron beams, etc. may be utilized.

Now, the present invention will be described more specifically below with reference to working examples. As a matter of course, the present invention is not limited to the following Examples. Wherever the terms “parts” and “%” are used hereinbelow, they invariably refer to those based on weight unless otherwise specified.

### EXAMPLE 1

Into a 200 ml four-necked flask equipped with a stirrer, a reflux condenser, and a thermometer, 10.6 parts of a bixylenol type epoxy resin (manufactured by Japan Epoxy Resin K.K., trade name YX-4000), 1.4 parts of 1,3,5-benzenetricarboxylic acid, 0.98 part of tetra-n-butylammonium bromide, and 50 ml of N-methylpyrrolidone were charged and left reacting for 24 hours at 80° C. Thereafter, 5.2 parts of methacrylic acid and 0.05 part of methoquinone were added to the reaction mixture and the resultant mixture was further left reacting for 12 hours at the same temperature. The resultant reaction solution was cooled to room temperature and poured into a large amount of water and the precipitated solid substance was recovered. Further, this solid substance was dissolved in tetrahydrofuran and the resultant solution was purified by pouring into a large amount of hexane. The resultant precipitate was filtered out and dried at reduced pressure to obtain 10.6 parts of an unsaturated group-containing multi-branched compound (A-1-1).

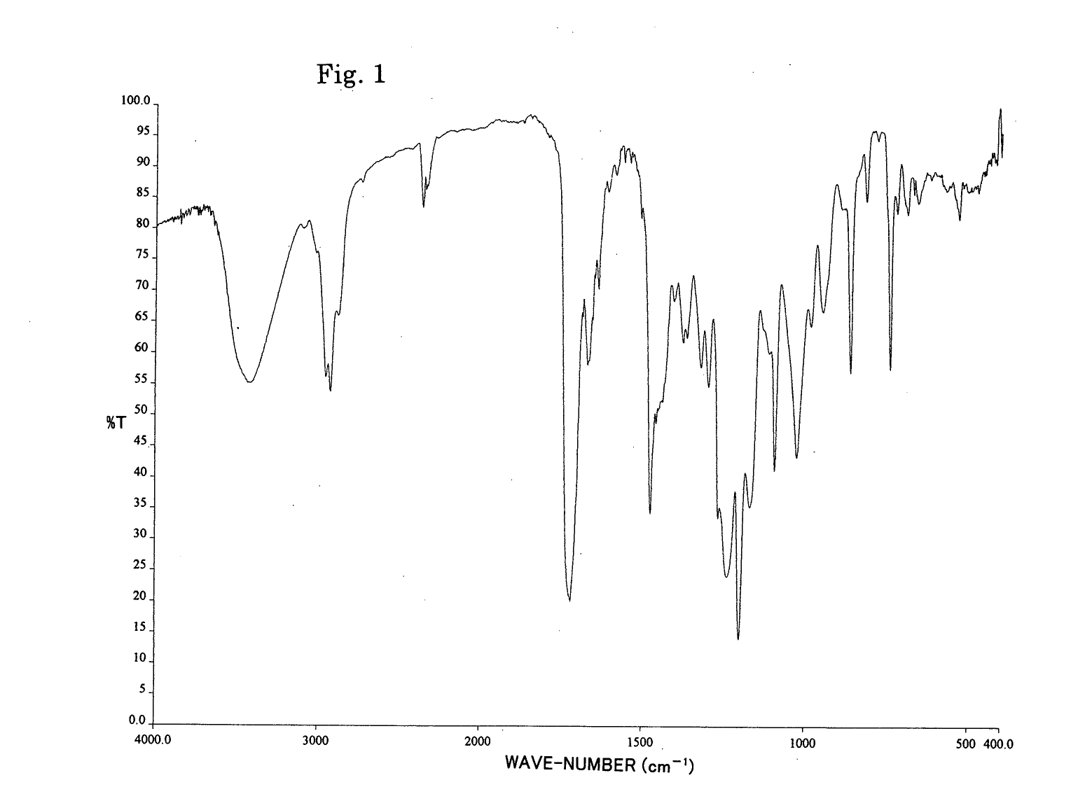

The structure of the obtained unsaturated group-containing multi-branched compound (A-1-1) was confirmed by the ¹H-NMR and IR spectrum. The IR spectrum of the unsaturated group-containing multi-branched compound obtained is shown in the FIG. 1. Since the absorption of νC═O and that of νC-O—C caused by the ester linkage, which show the fact that the of addition reaction had proceeded, appeared newly at 1718 cm⁻¹ and 1237 cm⁻¹ respectively and the absorption of the hydroxyl group caused by the ring opening addition reaction of an epoxy ring and the absorption originated from an unsaturated double bond were detected, it was confirmed that the obtained compound had the aimed structure. The number-average molecular weight of the compound determined by the GPC (gel permeation chromatography) was 4,000. The unsaturated group-containing multi-branched compound (A-1-1) had a double bond equivalent of 717.7 g/eq., a hydroxyl equivalent of 294.2 g/eq., and an acid value of 5.8 mgKOH/g.

### EXAMPLE 2

Into a 200 ml four-necked flask equipped with a stirrer, a reflux condenser, and a thermometer, 8.16 parts of a naphthalene type epoxy resin (manufactured by Dainippon Ink and Chemicals, Inc., trade name EPICLON HP-4032D), 2.1 parts of 1,3,5-benzenetricarboxylic acid, 0.98 part of tetra-n-butylammonium bromide, and 50 ml of N-methylpyrrolidone were charged and left reacting for 6 hours at 80° C. Thereafter, 5.2 parts of methacrylic acid and 0.05 part of methoquinone were added to the reaction mixture and the resultant mixture was further left reacting for 12 hours at the same temperature. The resultant reaction solution was cooled to room temperature and poured into a large amount of water and the precipitated solid substance was recovered. Further, this solid substance was dissolved in tetrahydrofuran and the resultant solution was purified by pouring into a large amount of hexane. The resultant precipitate was filtered out and dried at reduced pressure to obtain 4.89 parts of an unsaturated group-containing multi-branched compound (A-1-2).

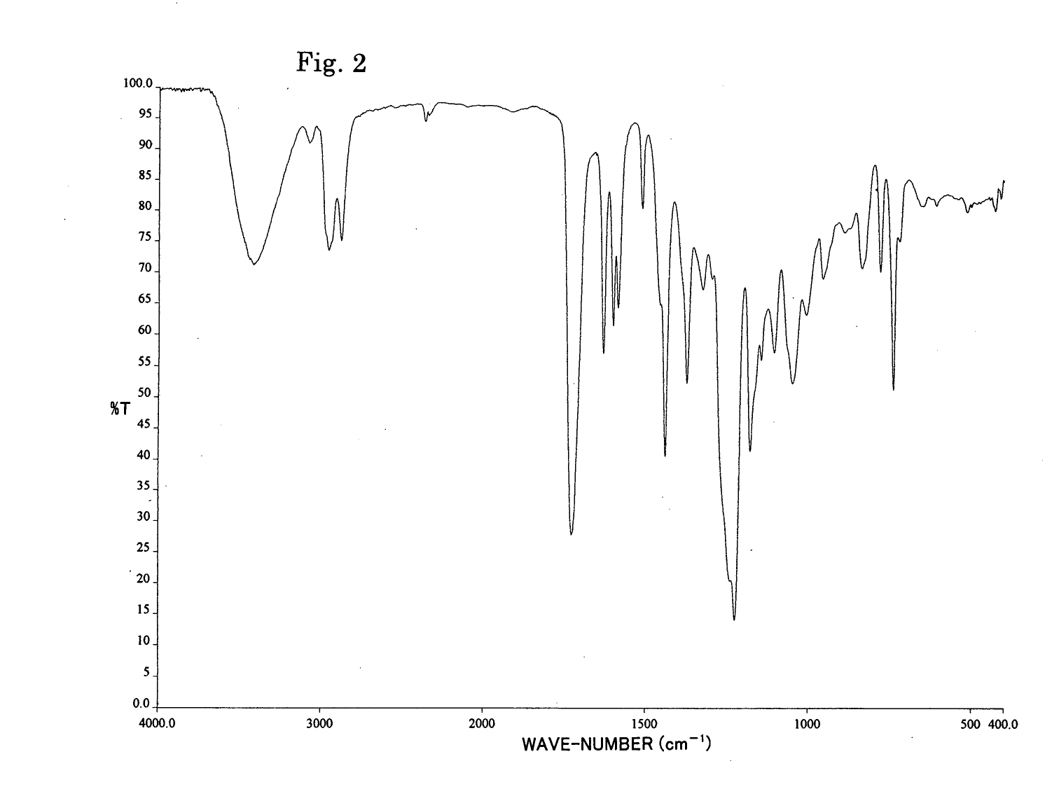

The structure of the obtained unsaturated group-containing multi-branched compound (A-1-2) was confirmed by the ¹H-NMR and IR spectrum. The IR spectrum of the unsaturated group-containing multi-branched compound obtained is shown in the FIG. 2. Since the absorption of νC═O and that of νC—O—C caused by the ester linkage, which show the fact that the addition reaction had proceeded, appeared newly at 1727 cm⁻¹ and 1237 cm⁻¹ respectively and the absorption of the hydroxyl group caused by the ring opening addition reaction of an epoxy ring and the absorption originated from an unsaturated double bond were detected, it was confirmed that the obtained compound had the aimed structure. The number-average molecular weight of the compound determined by the GPC (gel permeation chromatography) was 5,000. The unsaturated group-containing multi-branched compound (A-1-2) had a double bond equivalent of 817.3 g/eq., a hydroxyl equivalent of 258.7 g/eq., and an acid value of 2.6 mgKOH/g.

### EXAMPLE 3

Into a 200 ml four-necked flask equipped with a stirrer, a reflux condenser, and a thermometer, 13.6 parts of a naphthalene type epoxy resin (manufactured by Dainippon Ink and Chemicals, Inc., trade name EPICLON HP-4032D), 2.1 parts of 1,3,5-trisphenol, 3.39 parts of tetra-n-butylphosphonium bromide, and 50 ml of N-methylpyrrolidone were charged and left reacting for 24 hours at 100° C. Thereafter, 3.80 parts of methacrylic acid and 0.05 part of methoquinone were added to the reaction mixture and the resultant mixture was further left reacting for 6 hours at 80° C. Then, 22.0 parts of glycidyl methacrylate was added to the reaction mixture and the resultant mixture was further left reacting for 12 hours at 100° C. The resultant reaction solution was cooled to room temperature and poured into a large amount of water and the precipitated solid substance was recovered. Further, this solid substance was dissolved in tetrahydrofuran and the resultant solution was purified by pouring into a large amount of hexane. The resultant precipitate was filtered out and dried at reduced pressure to obtain 11.9 parts of an unsaturated group-containing multi-branched compound (A-3-1).

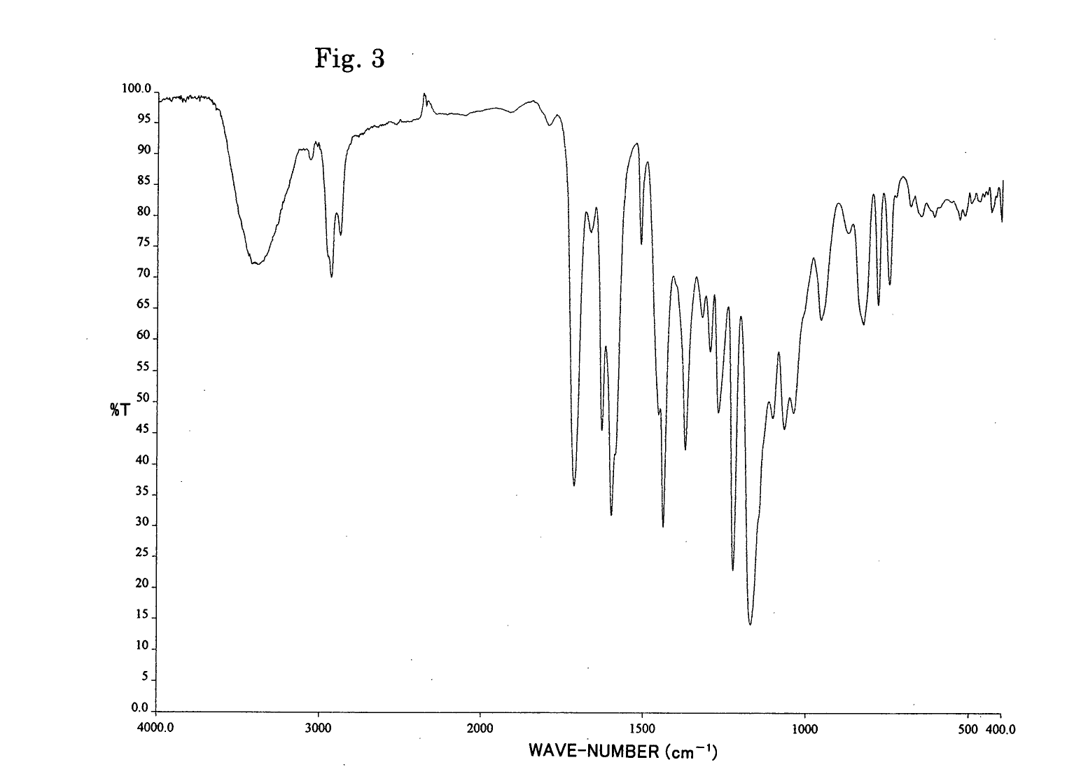

The structure of the obtained unsaturated group-containing multi-branched compound (A-3-1) was confirmed by the ¹H-NMR and IR spectrum. The IR spectrum of the unsaturated group-containing multi-branched compound obtained is shown in the FIG. 3. Since the absorption of νC—O—C caused by the ether linkage, which show the fact that the addition reaction had proceeded, appeared newly at 1718 cm⁻¹ and 1237 cm⁻¹ and the absorption of the hydroxyl group caused by the ring opening addition reaction of an epoxy ring and the absorption originated from an unsaturated double bond were detected, it was confirmed that the obtained compound had the aimed structure. The number-average molecular weight of the compound determined by the GPC (gel permeation chromatography) was 3,500. The unsaturated group-containing multi-branched compound (A-3-1) had a double bond equivalent of 717.7 g/eq., a hydroxyl equivalent of 294.2 g/eq., and an acid value of 5.8 mgKOH/g.

### EXAMPLE 4

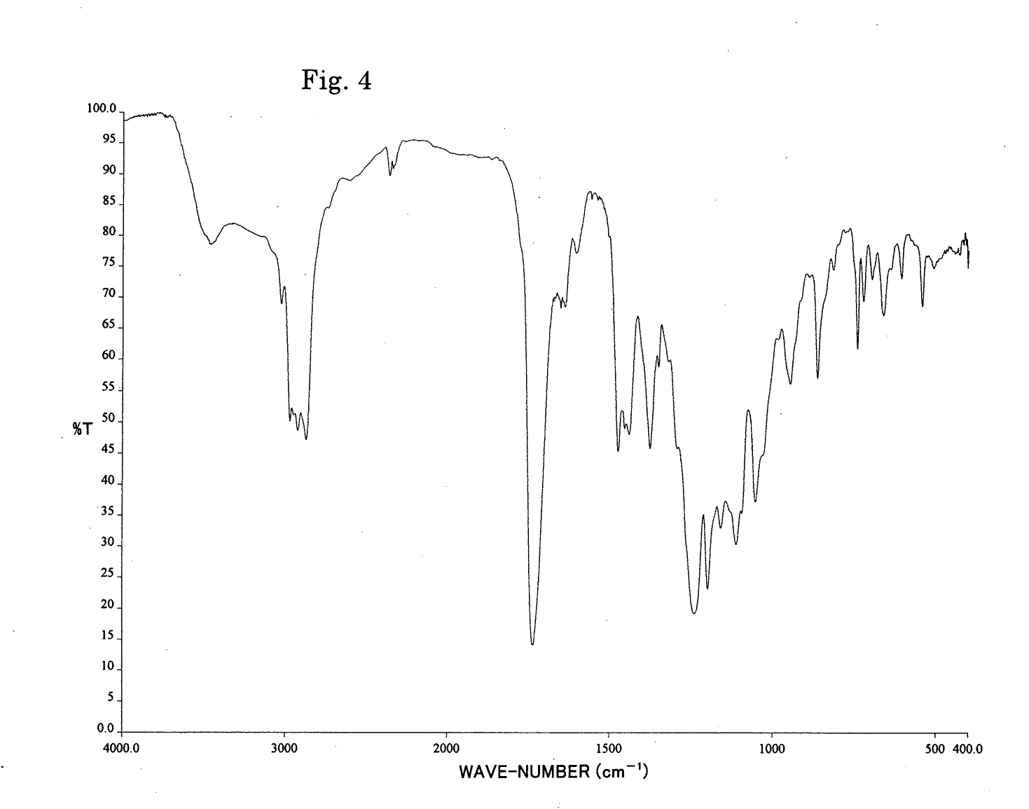

Into a 200 ml four-necked flask equipped with a stirrer, a reflux condenser, and a thermometer, 11.8 parts of the unsaturated group-containing multi-branched compound (A-1-1) obtained in Example 1, 3.6 parts of tetrahydrophthalic anhydride, 0.2 part of triphenylphosphine, 0.05 part of methoquinone, and 8.2 parts of carbitol acetate were charged and left reacting for 12 hours at 80° C. By using the resin solution (A-2-1) obtained, the confirmation of the structure was performed by the IR spectrum. The IR spectrum of the unsaturated group-containing multi-branched compound containing a carboxylic group and obtained as described above is shown in the FIG. 4. It has been confirmed that a carboxyl group was introduced in the side chain because the absorption at 1778 cm⁻¹ originated from ν C═O of tetrahydrophthalic anhydride disappeared completely and the broad absorption at about 3000 cm⁻¹ originated from the carboxyl group appeared. Further, as the result of the measurement of an acid value, the acid value, 5.8 mgKOH/g, of the unsaturated group-containing multi-branched compound before the introduction of the carboxyl group therein increased to 80 mgKOH/g after the introduction of the carboxyl group therein.

### EXAMPLE 5

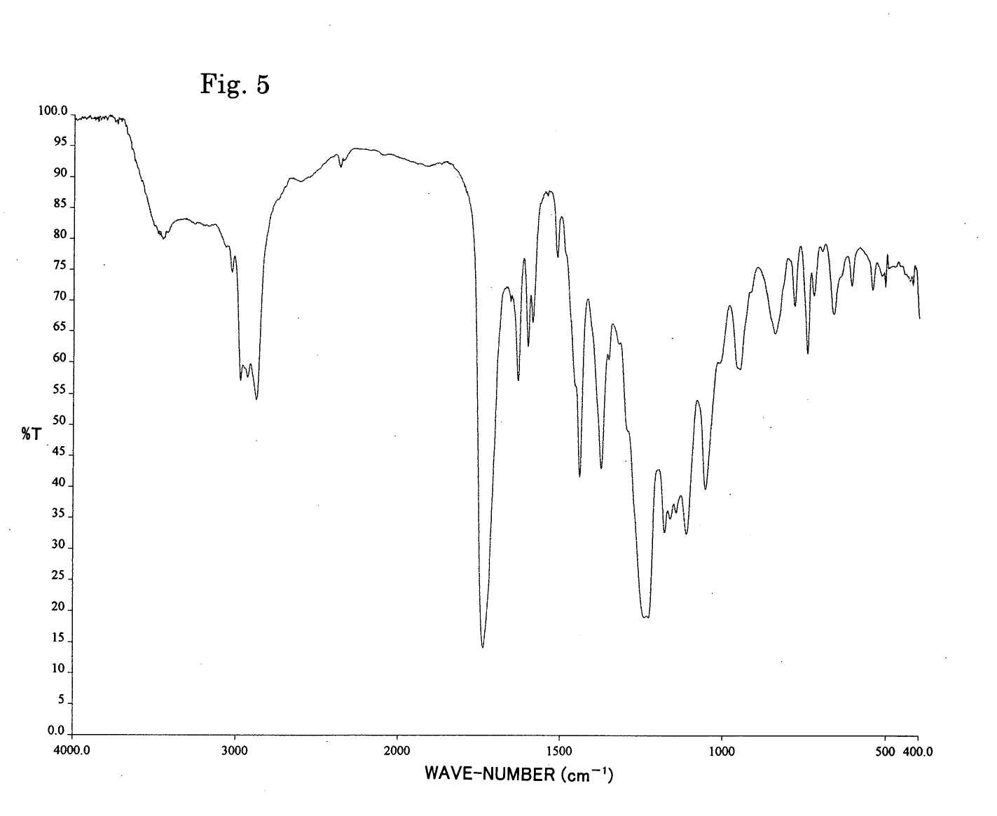

Into a 200 ml four-necked flask equipped with a stirrer, a reflux condenser, and a thermometer, 15.6 parts of the unsaturated group-containing multi-branched compound (A-1-2) obtained in Example 2, 5.9 parts of tetrahydrophthalic anhydride, 0.2 part of triphenylphosphine, 0.05 part of methoquinone, and 14.3 parts of carbitol acetate were charged and left reacting for 12 hours at 80° C. By using the resin solution (A-2-2) obtained, the confirmation of the structure was performed by the IR spectrum. The IR spectrum of the unsaturated group-containing multi-branched compound containing a carboxylic group and obtained as described above is shown in the FIG. 5. It has been confirmed that a carboxyl group was introduced in the side chain because the absorption at 1778 cm⁻¹ originated from ν C═O of tetrahydrophthalic anhydride disappeared completely and the broad absorption at about 3000 cm⁻¹ originated from the carboxyl group appeared. Further, as the result of the measurement of an acid value, the acid value, 2.6 mgKOH/g, of the unsaturated group-containing multi-branched compound before the introduction of the carboxyl group therein increased to 81.8 mgKOH/g after the introduction of the carboxyl group therein.

### EXAMPLE 6

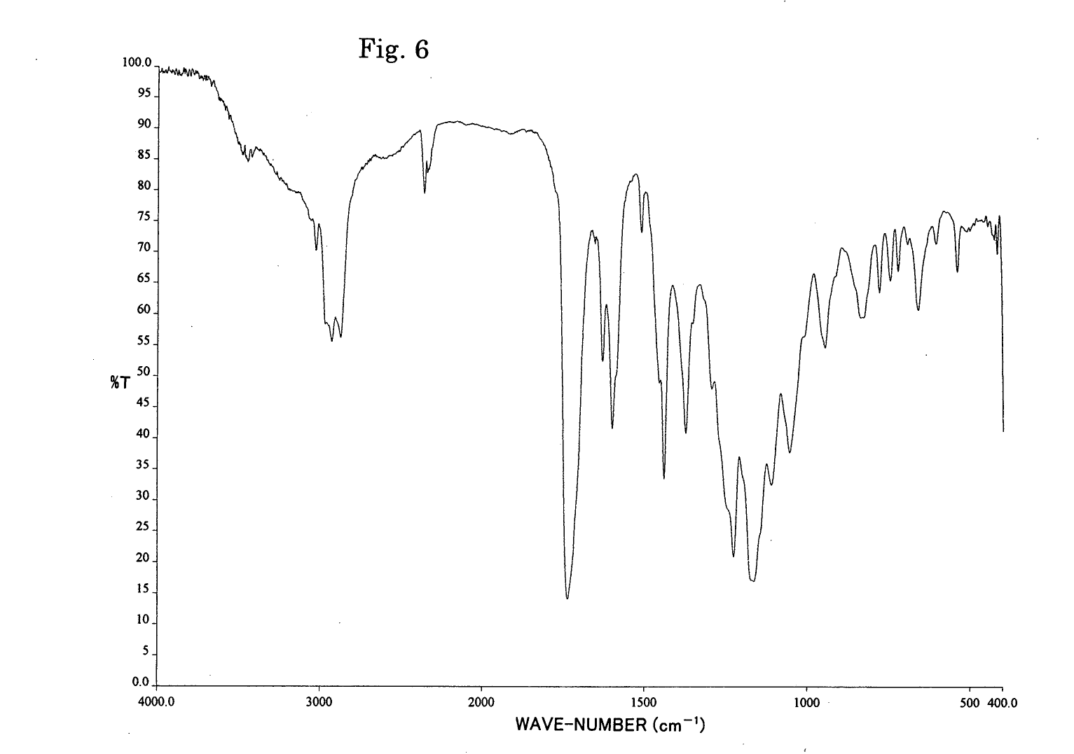

Into a 200 ml four-necked flask equipped with a stirrer, a reflux condenser, and a thermometer, 9.76 parts of the unsaturated group-containing multi-branched compound (A-3-1) obtained in Example 3, 4.56 parts of tetrahydrophthalic anhydride, 0.1 part of triphenylphosphine, 0.05 part of methoquinone, and 9.54 parts of carbitol acetate were charged and left reacting for 12 hours at 80° C. By using the resin solution (A-4-1) obtained, the confirmation of the structure was performed by the IR spectrum. The IR spectrum of the unsaturated group-containing multi-branched compound containing a carboxylic group and obtained as described above is shown in the FIG. 6. It has been confirmed that a carboxyl group was introduced in the side chain because the absorption at 1778 cm⁻¹ originated from ν C═O of tetrahydrophthalic anhydride disappeared completely and the broad absorption at about 3000 cm⁻¹ originated from the carboxyl group appeared. Further, as the result of the measurement of an acid value, the acid value, 5.8 mgKOH/g, of the unsaturated group-containing multi-branched compound before the introduction of the carboxyl group therein increased to 80 mgKOH/g after the introduction of the carboxyl group therein.

### EXAMPLE 7

Into a 200 ml four-necked flask equipped with a stirrer, a reflux condenser, and a thermometer, 12.8 parts of a bisphenol type epoxy resin (manufactured by Japan Epoxy Resin K.K., trade name YL-6810), 5.0 parts of tris(3-carboxypropyl)isocyanurate (manufactured by Shikoku Chemicals Co., Ltd., trade name C3-CIC acid), 2.0 parts of triphenylphosphine, and 50 ml of 1,4-dioxane were charged and left reacting for 6 hours at 90° C. Thereafter, 6.5 parts of methacrylic acid and 0.1 part of methoquinone were added to the reaction mixture and the resultant mixture was further left reacting for 12 hours at 90° C. The resultant reaction solution was cooled to room temperature. This solution was distilled under reduced pressure to obtain 13.1 parts of an unsaturated group-containing multi-branched compound (A-1-3) of a light yellow color.

The structure of the obtained unsaturated group-containing multi-branched compound was confirmed by the IR spectrum. The unsaturated group-containing multi-branched compound (A-1-3) mentioned above had an acid value of 2.0 mgKOH/g and a hydroxyl equivalent of 244.8 g/eq.

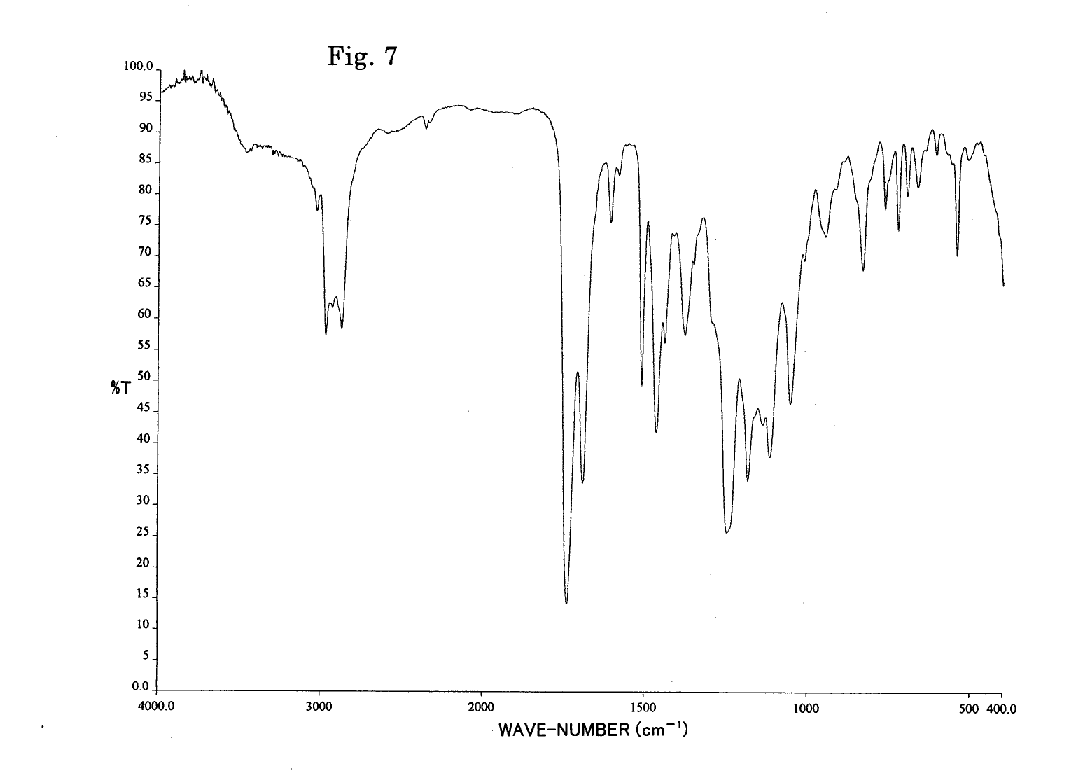

Into a 200 ml four-necked flask equipped with a stirrer, a reflux condenser, and a thermometer, 9.8 parts of the unsaturated group-containing multi-branched compound (A-1-3) mentioned above, 2.7 parts of tetrahydrophthalic anhydride, 0.1 part of triphenylphosphine, 0.05 part of methoquinone, and 8.3 parts of carbitol acetate were charged and left reacting for 12 hours at 80° C. By using the resin solution (A-2-3) obtained, the confirmation of the structure was performed by the IR spectrum. The IR spectrum of the unsaturated group-containing multi-branched compound containing a carboxylic group and obtained as described above is shown in the FIG. 7. It has been confirmed that a carboxyl group was introduced in the side chain because the absorption at 1778 cm⁻¹ originated from ν C═O of tetrahydrophthalic anhydride disappeared completely and the broad absorption at about 3000 cm⁻¹ originated from the carboxyl group appeared. Further, as the result of the measurement of an acid value, the acid value after addition of tetrahydrophthalic anhydride was 80 mgKOH/g.

The solubility characteristics of the unsaturated group-containing multi-branched compounds containing a carboxylic group introduced thereto ((A-2-1), (A-2-2), (A-2-3), and (A-4-1)) obtained as described above in various aqueous alkali solution were examined. The results are shown in Table 1.

TABLE 1

| | Solubility | | | |
|---|---|---|---|---|
| Solvent | (A-2-1) | (A-2-2) | (A-2-3) | (A-4-1) |
| Water | − | − | − | − |
| 1 wt. % Na₂CO₃ aqueous solution | ++ | ++ | ++ | ++ |
| 1 wt. % NaHCO₃ aqueous solution | ++ | ++ | ++ | ++ |
| 1 wt. % KOH aqueous solution | ++ | ++ | ++ | ++ |
| 2.38% Tetramethylammonium | ++ | ++ | ++ | ++ |
| hydroxide aqueous solution | | | | |

Remarks
−: Insoluble,
+: Soluble by heating,
++: Soluble

As being clear from the results shown in Table 1, the unsaturated group-containing multi-branched compounds containing a carboxylic group introduced therein and obtained as described above were soluble at room temperature in various aqueous alkali solution including an aqueous 1.0 wt. % sodium carbonate solution. The considerable reason for this fact is that the acid values of every unsaturated group-containing multi-branched compounds increased to about 80 mgKOH/g after introduction of the carboxyl group.

Application Examples 1-7 and Comparative Example 1

The components using each of the unsaturated group-containing multi-branched compounds ((A-1-1), (A-1-2), (A-2-1), (A-2-2), (A-2-3), (A-3-1), and (A-4-1)) obtained in Examples 1-7 and a novolak type epoxy acrylate resin to be described hereinbelow as a comparative sample were mixed at proportions shown in Table 2 and kneaded with a three-roll mill to prepare actinic energy ray-curable compositions. The properties of the cured coating films thereof were evaluated. The results are shown in Table 3.

TABLE 2

| Composition | Application Examples | | | | | | | Comp. |
|---|---|---|---|---|---|---|---|---|
| (parts by weight) | 1 | 2 | 3 | 4 | 5 | 6 | 7 | Ex. 1 |
| Unsaturated group- | 100 | — | — | — | — | — | — | — |
| containing multi- | | | | | | | | |
| branched compound (A-1-1) | | | | | | | | |
| Unsaturated group- | — | 100 | — | — | — | — | — | — |
| containing multi- | | | | | | | | |
| branched compound (A-1-2) | | | | | | | | |
| Unsaturated group- | — | — | 100 | — | — | — | — | — |
| containing multi- | | | | | | | | |
| branched compound (A-2-1) | | | | | | | | |
| Unsaturated group- | — | — | — | 100 | — | — | — | — |
| containing multi- | | | | | | | | |
| branched compound (A-2-2) | | | | | | | | |
| Unsaturated group- | — | — | — | — | — | — | 100 | — |
| containing multi- | | | | | | | | |
| branched compound (A-2-3) | | | | | | | | |
| Unsaturated group- | — | — | — | — | 100 | — | — | — |
| containing multi- | | | | | | | | |
| branched compound (A-3-1) | | | | | | | | |
| Unsaturated group- | — | — | — | — | — | 100 | — | — |
| containing multi- | | | | | | | | |
| branched compound (A-4-1) | | | | | | | | |
| Epoxy acrylate resin | — | — | — | — | — | — | — | 100 |
| Polyfunctional monomer*¹⁾ | 20 | 20 | 20 | 20 | 20 | 20 | 20 | 20 |
| Photopolymerization initiator*²⁾ | 10 | 10 | 10 | 10 | 10 | 10 | 10 | 10 |
| Thermal curing catalyst*³⁾ | — | — | 3 | 3 | — | 3 | 3 | 3 |
| Polyfunctional epoxy | — | — | 40 | 40 | — | 40 | 40 | 40 |
| resin*⁴⁾ | | | | | | | | |

Remarks
*¹⁾Dipentaerythritol hexaacrylate
*²⁾Irgacure 907 (photopolymerization initiator manufactured by Ciba Specialty Chemicals Inc.)
*³⁾2PHZ (manufactured by Shikoku Chemicals Co., Ltd., imidazole derivative)
*⁴⁾EPICLON N-695 (manufactured by Dainippon Ink & Chemicals, Inc.)

Novolak Type Epoxy Acrylate Resin

In a flask equipped with a gas introduction tube, a stirrer, a condenser, and a thermometer, 330 parts of a cresol novolak type epoxy resin (manufactured by Dainippon Ink & Chemicals, Inc., EPICLON N-695, epoxy equivalent; 220) and 400 parts of carbitol acetate added thereto were dissolved by heating. Then, 0.46 part of hydroquinone and 1.38 parts of triphenylphosphine were added to the solution. The resultant mixture kept heated to 95-105° C. and 108 parts of acrylic acid gradually added dropwise thereto were left reacting for 16 hours. The reaction product was cooled to 80-90° C. and made to add 163 parts of tetrahydrophthalic anhydride and they were left reacting for 8 hours. The reaction was followed up by the addition ratio obtained by the total acid value and the acid value of the reaction solution measured by potentiometric titration and the reaction ratio of 95% or more was regarded as the completion of the reaction. The novolak type epoxy acrylate resin consequently obtained was found to have a nonvolatile content of 58% and an acid value of 102 mg KOH/g as solids.

TABLE 3

| | Application Examples | | | | | | | Comp. |
|---|---|---|---|---|---|---|---|---|
| Properties | 1 | 2 | 3 | 4 | 5 | 6 | 7 | Ex. 1 |
| Tensile Modulus (MPa) | 2010 | — | 2180 | — | 2640 | 2750 | 2410 | 2040 |
| Tensile Strength (MPa) | 40.5 | — | 62.3 | — | 54.3 | 76.6 | 58.8 | 20.0 |
| Elongation (%) | 3.6 | — | 5.2 | — | 3.1 | 4.3 | 3.3 | 1.2 |
| Resistance to | ◯ | ◯ | ◯ | ◯ | ◯ | ◯ | ◯ | ◯ |
| Soldering Heat | | | | | | | | |
| Adhesiveness | ◯ | ◯ | ◯ | ◯ | ◯ | ◯ | ◯ | Δ |
| 180° Bending | ◯ | ◯ | ◯ | ◯ | ◯ | ◯ | ◯ | X |
| Toughness | | | | | | | | |

As being clear from the results shown in Table 3, the actinic energy ray-curable compositions of Application Examples 1 to 7 using the unsaturated group-containing multi-branched compounds ((A-1-1), (A-1-2), (A-2-1), (A-2-2), (A-2-3), (A-3-1), or (A-4-1)) obtained in Examples 1-7 of the present invention gives the cured products excelling in toughness and flexibility as compared with Comparative Example 1 using the usual epoxy acrylate resin.

The methods for evaluating the characteristics shown in Table 3 are as follows:

Tensile Modulus, Tensile Strength (tensile strength at break), and Elongation (tensile elongation at break):

These properties were determined in accordance with JIS (Japanese Industrial Standard) K 7127.

Resistance to Soldering Heat:

Each of the actinic energy ray-curable compositions of Application Examples 3, 4, 6, and 7 and Comparative Example 1 was applied by the screen printing method to the entire surface of a printed circuit board having a circuit formed in advance thereon to form a coating film of about 20 μm thickness. The coating film on the board was then dried at 80° C. for 30 minutes by heating. Thereafter, the board was exposed to light through a negative film under the conditions of irradiation dose of 500 mJ/cm². Then, the coating film was developed for one minute with an aqueous alkali solution and further thermally cured at 150° C. for 60 minutes to prepare a test board. With respect to Application Examples 1, 2, and 5 mentioned above, the actinic energy ray-curable composition was printed by the screen printing method to the entire surface of a printed circuit board having a circuit formed in advance thereon to form a coating film of about 20 μm thickness in a prescribed pattern. The coating film was photocured by exposure to light under the conditions of irradiation dose of 500 mJ/cm² to prepare a test board.

Each of the test boards prepared as described above was coated with a rosin type flux and subjected to the step of immersing for 30 seconds in a solder bath set in advance at 260° C. repeated three times, and visually examined to find the extents of swelling, separation, and discoloration consequently produced in the coating film.
◯: Perfect absence of any discernible change was found.
Δ: Slight change was found.
X: Swelling or separation of the coating film was found.
   Adhesiveness:

The test boards which had been subjected to the test for resistance to soldering heat mentioned above were used. Each coating film was incised like cross-cut in the shape of squares and then subjected to a peeling test with an adhesive tape to visually examine the degree of separation of the coating film.
◯: Perfect absence of separation was found.
Δ: Separation at the cross-cut portion was found.
X: Separation was found.
   180° Bending Toughness:

Each of the actinic energy ray-curable compositions of Application Examples 1-7 and Comparative Example 1 was applied to an aluminum foil by means of a bar coater to form a coating film of 70 μm thickness and then irradiated with a high-pressure mercury lamp for 120 seconds to form a cured film. This film was folded 180° over itself to visually examine the presence or absence of cracks in the film.
◯: Absence of crack in the film was found.
X: Presence of cracks in the film was gound.

As described above, the unsaturated group-containing multi-branched compounds (A-1)-(A-4) of the present invention are capable of curing promptly by short-time irradiation of an actinic energy ray and further capable of curing by heating. Further, the resultant cured products exhibit excellent adhesiveness to various substrates. Moreover, they exhibit slight shrinkage on curing and give the cured products excelling in mechanical properties such as strength, elongation, and toughness. Furthermore, the compounds exhibit high solubility in various solvents and have the characteristic of lowering the viscosity of their solutions owing to the multi-branched structure. Since the unsaturated group-containing multi-branched compounds (A-5)-(A-8) of the present invention having a carboxyl group have a large number of polymerizable groups at terminals as described above, they are the resins exhibiting excellent photocuring properties. Further, since they have carboxyl groups introduced therein by the reaction of the polybasic acid anhydride to the pendant hydroxyl group of each of the unsaturated group-containing multi-branched compounds (A-1) to (A-4), they exhibit excellent solubility in an aqueous alkaline solution and thus are useful as an alkali-developing type photosensitive resin.

Accordingly, the unsaturated group-containing multi-branched compounds ((A-1) to (A-8)) of the present invention may be advantageously used as a photocurable component and/or a thermosetting component in various application fields because they have excellent properties as mentioned above.

Furthermore, since the curable composition of the present invention comprising the aforementioned unsaturated group-containing multi-branched compound (either one or a mixture of two or more of (A-1) to (A-8)) together with a polymerization initiator or the photocurable and thermosetting composition further comprising a thermosetting component cures promptly by irradiation of an actinic energy ray such as an ultraviolet ray or an electron beam or further cures by heating, excels in adhesiveness to a substrate, and allows formation of a cured product excelling in mechanical properties such as strength and toughness and in other properties such as resistance to heat, heat stability, flexibility, resistance to chemicals, and electrical insulation properties. Accordingly, one can expect these compositions to be used in wide range of application fields as an adhesive, a coating material, and a solder resist, an etching resist, an interlaminar insulating material for a build-up board, a plating resist and a dry film to be used in the manufacture of printed circuit boards.

While certain specific working examples have been disclosed herein, the invention may be embodied in other specific forms without departing from the spirit or essential characteristics thereof. The described examples are therefore to be considered in all respects as illustrative and not restrictive, the scope of the invention being indicated by the appended claims rather than by the foregoing description and all changes which come within the meaning and range of equivalency of the claims are, therefore, intended to be embraced therein.

The International Application PCT/JP03/04121, filed Mar. 31, 2003, describes the invention described hereinabove and claimed in the claims appended hereinbelow, the disclosure of which is incorporated here by reference.

1. An unsaturated group-containing multi-branched compound, which is either one of the following compounds and has a multi-branched structure having at least two photosensitive, unsaturated double bonds at its terminal parts:
(1) a compound obtained by the reaction of (a) a compound containing at least two epoxy groups in its molecule with (b) a compound containing at least two (but at least three when the component (a) mentioned above is a compound containing two epoxy groups) carboxyl groups in its molecule and (c′) a compound containing at least one unsaturated double bond-containing group,
(2) a compound obtained by the reaction of (a) a compound containing at least two epoxy groups in its molecule with (b′) a phenolic compound containing at least two (but at least three when the component (a) mentioned above is a compound containing two epoxy groups) hydroxyl groups in its molecule and (c′) a compound containing at least one unsaturated double bond-containing group, and
(3) a compound obtained by the reaction of (a) a compound containing at least two epoxy groups in its molecule with (b″) a compound containing at least one (but at least three functional groups in total when the component (a) mentioned above is a compound containing two epoxy groups) of carboxyl group and phenolic hydroxyl group severally in its molecule and (c′) a compound containing at least one unsaturated double bond-containing group.

2. The unsaturated group-containing multi-branched compound according to claim 1, wherein said compound (c′) containing at least one unsaturated double bond-containing group is (c) an unsaturated monocarboxylic acid.

3. An unsaturated group-containing multi-branched compound, which is either one of the following compounds and has a multi-branched structure having at least two photosensitive, unsaturated double bonds at its terminal parts and at least one carboxyl group:
(1) a compound obtained by reacting (d) a polybasic acid anhydride with a hydroxyl group of an unsaturated group-containing multi-branched compound obtained by the reaction of (a) a compound containing at least two epoxy groups in its molecule with (b) a compound containing at least two (but at least three when the component (a) mentioned above is a compound containing two epoxy groups) carboxyl groups in its molecule and (c′) a compound containing at least one unsaturated double bond-containing group,
(2) a compound obtained by reacting (d) a polybasic acid anhydride with a hydroxyl group of an unsaturated group-containing multi-branched compound obtained by the reaction of (a) a compound containing at least two epoxy groups in its molecule with (b′) a phenolic compound containing at least two (but at least three when the component (a) mentioned above is a compound containing two epoxy groups) hydroxyl groups in its molecule and (c′) a compound containing at least one unsaturated double bond-containing group, and
(3) a compound obtained by reacting (d) a polybasic acid anhydride with a hydroxyl group of an unsaturated group-containing multi-branched compound obtained by the reaction of (a) a compound containing at least two epoxy groups in its molecule with (b″) a compound containing at least one (but at least three functional groups in total when the component (a) mentioned above is a compound containing two epoxy groups) of carboxyl group and phenolic hydroxyl group severally in its molecule and (c′) a compound containing at least one unsaturated double bond-containing group.

4. The unsaturated group-containing multi-branched compound according to claim 3, wherein said compound (c′) containing at least one unsaturated double bond-containing group is (c) an unsaturated monocarboxylic acid.

5. A curable composition, comprising (A) the unsaturated group-containing multi-branched compound set forth claim 1 and (B) a polymerization initiator as essential components.

6. The curable composition according to claim 5, further comprising (C) a thermosetting component.

7. A curable composition, comprising (A) the unsaturated group-containing multi-branched compound set forth claim 3 and (B) a polymerization initiator as essential components.

8. The curable composition according to claim 7, further comprising (C) a thermosetting component.

9. A curable composition, comprising as essential components:
(A) at least two unsaturated group-containing multi-branched compounds selected from the group consisting of
(1) a compound obtained by the reaction of (a) a compound containing at least two epoxy groups in its molecule with (b) a compound containing at least two (but at least three when the component (a) mentioned above is a compound containing two epoxy groups) carboxyl groups in its molecule and (c′) a compound containing at least one unsaturated double bond-containing group,
(2) a compound obtained by the reaction of (a) a compound containing at least two epoxy groups in its molecule with (b′) a phenolic compound containing at least two (but at least three when the component (a) mentioned above is a compound containing two epoxy groups) hydroxyl groups in its molecule and (c′) a compound containing at least one unsaturated double bond-containing group,
(3) a compound obtained by the reaction of (a) a compound containing at least two epoxy groups in its molecule with (b″) a compound containing at least one (but at least three functional groups in total when the component (a) mentioned above is a compound containing two epoxy groups) of carboxyl group and phenolic hydroxyl group severally in its molecule and (c′) a compound containing at least one unsaturated double bond-containing group,
(4) a compound obtained by reacting (d) a polybasic acid anhydride with a hydroxyl group of an unsaturated group-containing multi-branched compound obtained by the reaction of (a) a compound containing at least two epoxy groups in its molecule with (b) a compound containing at least two (but at least three when the component (a) mentioned above is a compound containing two epoxy groups) carboxyl groups in its molecule and (c′) a compound containing at least one unsaturated double bond-containing group,
(5) a compound obtained by reacting (d) a polybasic acid anhydride with a hydroxyl group of an unsaturated group-containing multi-branched compound obtained by the reaction of (a) a compound containing at least two epoxy groups in its molecule with (b′) a phenolic compound containing at least two (but at least three when the component (a) mentioned above is a compound containing two epoxy groups) hydroxyl groups in its molecule and (c′) a compound containing at least one unsaturated double bond-containing group, and
(6) a compound obtained by reacting (d) a polybasic acid anhydride with a hydroxyl group of an unsaturated group-containing multi-branched compound obtained by the reaction of (a) a compound containing at least two epoxy groups in its molecule with (b″) a compound containing at least one (but at least three functional groups in total when the component (a) mentioned above is a compound containing two epoxy groups) of carboxyl group and phenolic hydroxyl group severally in its molecule and (c′) a compound containing at least one unsaturated double bond-containing group, and
(B) a polymerization initiator.

10. The curable composition according to claim 9, further comprising (C) a thermosetting component.

11. The curable composition according to claim 9, wherein said compound (c′) containing at least one unsaturated double bond-containing group is (c) an unsaturated monocarboxylic acid.

12. A cured product obtained by curing the curable composition set forth in claim 5 by irradiation with an actinic energy ray or by heating.

13. A cured product obtained by curing the curable composition set forth in claim 6 by irradiation with an actinic energy ray or by heating.

14. A cured product obtained by curing the curable composition set forth in claim 7 by irradiation with an actinic energy ray or by heating.

15. A cured product obtained by curing the curable composition set forth in claim 8 by irradiation with an actinic energy ray or by heating.

16. A cured product obtained by curing the curable composition set forth in claim 9 by irradiation with an actinic energy ray or by heating.

17. A cured product obtained by curing the curable composition set forth in claim 10 by irradiation with an actinic energy ray or by heating.

18. A printed circuit board, comprising a circuit board containing an electrically conductor layer of a prescribed circuit pattern and a solder resist film as a permanent protective film formed on said circuit board, wherein said solder resist film comprises a cured coating film of the curable composition set forth in claim 5.

19. A printed circuit board, comprising a circuit board containing an electrically conductor layer of a prescribed circuit pattern and a solder resist film as a permanent protective film formed on said circuit board, wherein said solder resist film comprises a cured coating film of the curable composition set forth in claim 6.

20. A printed circuit board, comprising a circuit board containing an electrically conductor layer of a prescribed circuit pattern and a solder resist film as a permanent protective film formed on said circuit board, wherein said solder resist film comprises a cured coating film of the curable composition set forth in claim 7.

21. A printed circuit board, comprising a circuit board containing an electrically conductor layer of a prescribed circuit pattern and a solder resist film as a permanent protective film formed on said circuit board, wherein said solder resist film comprises a cured coating film of the curable composition set forth in claim 8.

22. A printed circuit board, comprising a circuit board containing an electrically conductor layer of a prescribed circuit pattern and a solder resist film as a permanent protective film formed on said circuit board, wherein said solder resist film comprises a cured coating film of the curable composition set forth in claim 9.

23. A printed circuit board, comprising a circuit board containing an electrically conductor layer of a prescribed circuit pattern and a solder resist film as a permanent protective film formed on said circuit board, wherein said solder resist film comprises a cured coating film of the curable composition set forth in claim 10.
